(19) United States
(12) Patent Application Publication
(10) Pub. No.: US 2025/0359593 A1
(43) Pub. Date: Nov. 27, 2025

(54) AEROSOL-GENERATING DEVICE AND METHOD OF MANUFACTURING THE SAME

(71) Applicant: KT&G CORPORATION, Daejeon (KR)

(72) Inventors: Youngbum KWON, Gyeonggi-do (KR); Dongsung KIM, Seoul (KR); Yonghwan KIM, Gyeonggi-do (KR); Hwikyeong AN, Seoul (KR)

(73) Assignee: KT&G CORPORATION, Daejeon (KR)

(21) Appl. No.: 19/095,450

(22) Filed: Mar. 31, 2025

(30) Foreign Application Priority Data
May 22, 2024 (KR) 10-2024-0066190

(51) Int. Cl. A24F 40/46

(52) U.S. Cl. CPC A24F 40/46

(57) ABSTRACT

An aerosol-generating device is disclosed. The aerosol-generating device includes a body and a hollow heater assembly disposed in the body and providing an insertion space with one side open. The heater assembly includes a heating element configured to heat the insertion space, an insulator forming multiple layers surrounding the outer side of the heating element in the radial direction of the insertion space, and a through-hole formed through the multiple layers. The through-hole is formed by overlapping holes formed in the multiple layers.

### CROSS-REFERENCE TO RELATED APPLICATIONS

Pursuant to 35 U.S.C. § 119 (a), this application claims the benefit of earlier filing date and right of priority to Korean Patent Application No. 10-2024-0066190 filed on May 22, 2024, the contents of which are all hereby incorporated by reference herein in their entireties.

### BACKGROUND OF THE DISCLOSURE

### 1. Field of the Disclosure

The present disclosure relates to an aerosol-generating device and a method of manufacturing the same.

### 2. Description of the Related Art

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

In general, an insulator using a polyimide film is used for a cylindrical external heater that receives an aerosol-generating substance therein and heats the same. An external heater having a structure in which an insulator is rolled multiple times has a problem in that each layer thereof is lifted or delaminated due to voids generated in each layer during the process of manufacturing the heater and/or the process of using the heater.

### SUMMARY OF THE DISCLOSURE

It is an object of the present disclosure to solve the above and other problems.

It is another object of the present disclosure to provide an aerosol-generating device including a heater assembly in which a through-hole is formed through an insulator formed outside a heating element.

It is still another object of the present disclosure to provide an aerosol-generating device including a heater assembly in which the outer surface of the heating element communicates with the outside of the insulator through the through-hole.

It is still another object of the present disclosure to provide an aerosol-generating device including a heater assembly in which the centers of holes forming the through-hole are disposed so as to be misaligned from each other.

It is still another object of the present disclosure to provide a method of manufacturing an aerosol-generating device in which a sheet forming the insulator is rolled together with the heating element to manufacture a heater assembly and the manufactured heater assembly is aged.

It is still another object of the present disclosure to provide a method of manufacturing an aerosol-generating device in which the heater assembly is aged based on a heating time and a heating temperature set within predetermined ranges.

In accordance with an aspect of the present disclosure for accomplishing the above and other objects, there is provided an aerosol-generating device including a body and a hollow heater assembly disposed in the body and providing an insertion space with one side open, wherein the heater assembly includes a heating element configured to heat the insertion space, an insulator forming multiple layers surrounding the outer side of the heating element in the radial direction of the insertion space, and a through-hole formed through the multiple layers, and the through-hole is formed by overlapping holes formed in the multiple layers.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF THE DRAWINGS

The above and other objects, features, and other advantages of the present disclosure will be more clearly understood from the following detailed description taken in conjunction with the accompanying drawings, in which:

FIGS. 1 and 2 are views showing an aerosol-generating device according to embodiments of the present disclosure;

FIG. 3 is a view showing a stick according to an embodiment of the present disclosure;

FIG. 4 is a front perspective view of a heater assembly according to an embodiment of the present disclosure;

FIG. 5 is an exploded perspective view of the heater assembly according to the embodiment of the present disclosure;

FIG. 6 is a view showing a heating element of the heater assembly according to the embodiment of the present disclosure;

FIG. 7 is a cross-sectional view of the heater assembly according to the embodiment of the present disclosure;

FIGS. 8 and 9 are cross-sectional views showing a through-hole of the heater assembly according to the embodiment of the present disclosure;

FIG. 10 is a flowchart showing a method of manufacturing the heater assembly according to an embodiment of the present disclosure;

FIGS. 11 and 12 are views showing an unfolded state of the heater assembly according to the embodiment of the present disclosure;

FIG. 13 is a view showing holes in an insulator of the heater assembly according to the embodiment of the present disclosure;

FIG. 14 is a flowchart showing a step of aging the heater assembly according to an embodiment of the present disclosure;

FIG. 15 shows comparison images of a conventional heater assembly and the heater assembly aged according to the heater assembly manufacturing method of the embodiment of the present disclosure; and

FIG. 16 is a block diagram of an aerosol-generating device according to an embodiment of the present disclosure.

### DETAILED DESCRIPTION OF THE PREFERRED EMBODIMENTS

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Throughout the present specification, the directions of an insulator sheet of a heater assembly of an aerosol-generating device may be defined based on an orthogonal coordinate system. In the orthogonal coordinate system, the x-axis direction may be defined as a leftward-rightward direction or a longitudinal direction of the insulator sheet. The y-axis direction may be defined as a forward-backward direction or a width direction of the insulator sheet. The z-axis direction may be defined as an upward-downward direction or a thickness direction of the insulator sheet.

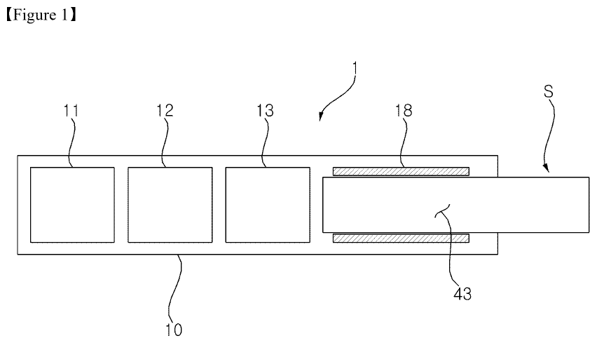

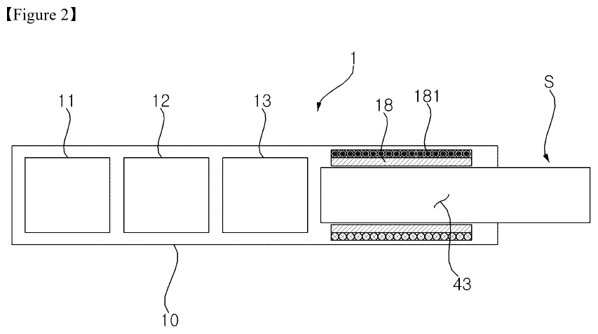

FIGS. 1 and 2 are views showing aerosol-generating devices 1 according to embodiments of the present disclosure.

Referring to FIGS. 1 and 2, an aerosol-generating device 1 according to embodiments of the present disclosure may include at least one of a power supply 11, a controller 12, a sensor 13, or a heater 18. At least one of the power supply 11, the controller 12, the sensor 13, or the heater 18 may be disposed in a body 10 of the aerosol-generating device. The body 10 may define a space having an open top to allow a stick S, which is an aerosol-generating article, to be inserted thereinto. The space having an open top may be referred to as an insertion space 43. The insertion space 43 may be formed so as to be depressed to a predetermined depth toward the interior of the body 10 so that the stick S is inserted at least partway thereinto. The depth of the insertion space 43 may correspond to the length of the portion of the stick S that contains an aerosol-generating substance and/or medium. The lower end of the stick S may be inserted into the body 10, and the upper end of the stick S may protrude to the outside of the body 10. A user may inhale air in a state of holding the upper end of the stick S, which is exposed to the outside, in the mouth.

The heater 18 may heat a stick S. The heater 18 may be disposed around a space into which the stick S is inserted and may be elongated upward. For example, the heater 18 may be formed in a shape of a tube including a cavity formed therein. The heater 18 may be disposed around an insertion space 43. The heater 18 may be disposed so as to surround at least a portion of the insertion space 43. The heater 18 may heat the insertion space 43 or the stick S inserted into the insertion space 43. The heater 18 may include an electro-resistive heater and/or an induction heater.

For example, referring to FIG. 1, the heater 18 may be a resistive heater. For example, the heater 18 may include an electrically conductive track (heating-element) and may be heated as current flows through the electrically conductive track. The heater 18 may be electrically connected to the power supply 11. The heater 18 may directly generate heat using current received from the power supply 11.

For example, referring to FIG. 2, the aerosol-generating device may include an induction coil 181 surrounding the heater 18. The induction coil 181 may cause the heater 18 to generate heat. The heater 18 may generate heat using a magnetic field generated by alternating current flowing through the induction coil 181. The magnetic field may pass through the heater 18 to generate an eddy current in the heater 18. The current may cause the heater 18 to generate heat.

Meanwhile, a susceptor may be included in the stick S, and the susceptor in the stick S may generate heat using a magnetic field generated by alternating current flowing through the induction coil 181.

The power supply 11 may supply power so that components of the aerosol-generating device operate. The power supply 11 may be referred to as a battery. The power supply 11 may supply power to at least one of the controller 12, the sensor 13, or the heater 18. The power supply 11 may supply power to the induction coil 181.

The controller 12 may control overall operation of the aerosol-generating device. The controller may be mounted on a printed circuit board (PCB). The controller 12 may control operation of at least one of the power supply 11, the sensor 13, or the heater 18. The controller 12 may control operation of a display, a motor, etc. mounted in the aerosol-generating device. The controller 12 may check the state of each of the components of the aerosol-generating device and may determine whether the aerosol-generating device is in an operable state.

The controller 12 may analyze a result of detection by the sensor 13 and may control subsequent processes. For example, the controller 12 may control, based on a result of detection by the sensor 13, power supplied to the heater 18 so that operation of the heater 18 commences or ends. For example, the controller 12 may control, based on a result of detection by the sensor 13, the amount of power supplied to the heater 18 and a power supply time so that the heater 18 is heated to a predetermined temperature or is maintained at an appropriate temperature.

The sensor 13 may include at least one of a temperature sensor, a puff sensor, or an insertion detection sensor. For example, the sensor 13 may detect at least one of the temperature of the heater 18, the temperature of the power supply 11, or the internal/external temperature of the body 10. For example, the sensor 13 may detect a user puff. For example, the sensor 13 may detect whether the stick S is inserted into the insertion space 43.

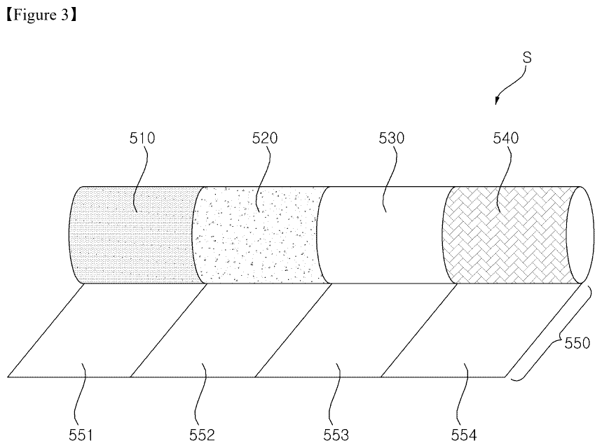

FIG. 3 is a view showing a stick according to an embodiment of the present disclosure.

Referring to FIG. 3, the stick S may include an aerosol base portion 510. The stick S may include a medium portion 520. The aerosol base portion 510 and the medium portion 520 may be referred to as a tobacco rod. The stick S may include a cooling portion 530. The stick S may include a filter portion 540. The stick S may include a wrapper 550 that surrounds the aerosol base portion 510, the medium portion 520, the cooling portion 530 and/or the filter portion 540. In FIG. 3, the wrapper 550 may include individual wrappers that surround the aerosol base portion 510, the medium portion 520, and the filter portion 540, respectively, and/or an outer shell that surrounds the aerosol base portion 510, the medium portion 520, and the filter portion 540, which are surrounded by the individual wrappers, in one piece.

The aerosol base portion 510 may be a portion formed in a preset shape by containing a moisturizer in pulp-based paper. The moisturizer (a base material) contained in the aerosol base portion 510 may include propylene glycol and glycerin. For example, the moisturizer of the aerosol base portion 510 may include propylene glycol and glycerin having a certain weight ratio to the weight of base paper. When the stick S is inserted into the aerosol-generating device 1 and is heated to a temperature above a predetermined level by the heater 18, moisturizer vapor may be generated from the aerosol base portion 510.

The medium portion 520 may include at least one of a sheet, a strand, or pipe tobacco formed of tiny bits of a shredded tobacco sheet. The medium portion 520 may be a portion that generates nicotine in order to provide a smoking experience to a user. When the temperature of the medium contained in the medium portion 520 rises to a predetermined temperature or higher, nicotine vapor may be generated from the medium portion 520. When the stick S is inserted into the aerosol-generating device 1, at least part of the aerosol base portion 510 and at least part of the medium portion 520 may face the heater 18. For example, a part of the upstream side or the downstream side of the aerosol base portion 510 and a part of the downstream side or the upstream side of the medium portion 520 may face the heater 18.

The length of the part of the medium portion 520 that faces the heater 18 may be greater than the length of the part of the aerosol base portion 510 that faces the heater 18. The length of the part of the aerosol base portion 510 that faces the heater 18 may be greater than or equal to half the overall length of the aerosol base portion 510. The length of the part of the medium portion 520 that faces the heater 18 may be greater than or equal to half the overall length of the medium portion 520.

The part of the aerosol base portion 510 and the part of the medium portion 520 that face the heater 18 may be heated by the heater 18. Because at least part of the aerosol base portion 510 containing the moisturizer is heated by the heater 18, moisturizer vapor may be generated. Because at least part of the medium portion 520 containing the medium is heated by the heater 18, nicotine vapor may be generated. As the stick S is disposed so as to vary a ratio of the length of the part of the aerosol base portion 510 that faces the heater 18 to the length of the part of the medium portion 520 that faces the heater 18, a ratio of the amount of moisturizer vapor generated to the amount of nicotine vapor generated may be appropriately adjusted.

In an embodiment, although the stick S is inserted into the aerosol-generating device 1, the medium portion 520 may not be directly heated by the heater 18. The medium portion 520 may be indirectly heated from the aerosol base portion 510 and the medium-portion wrapper (or the wrapper) surrounding the medium portion 520 through conduction, convection, and radiation. After the aerosol base portion 510 is heated through the heater 18, the temperature of the medium portion 520 may be indirectly increased.

The cooling portion 530 may be manufactured as a tube filter containing a predetermined weight of plasticizer. The moisturizer vapor and the nicotine vapor generated from the aerosol base portion 510 and the medium portion 520 may be mixed with each other to be aerosolized, and may be cooled while passing through the cooling portion 530. According to an embodiment, the cooling portion 530 may not be surrounded by the individual wrapper, unlike the aerosol base portion 510, the medium portion 520, and the filter portion 540.

The filter portion 540 may be a cellulose acetate filter. Meanwhile, there is no limitation on the shape of the filter portion 540. The filter portion 540 may be a cylindrical-type rod or may be of a tube type including a cavity formed therein. For example, when the filter portion 540 is composed of a plurality of segments, at least one of the plurality of segments may be manufactured in a different shape. The filter portion 540 may be manufactured so as to generate a flavor. In an example, a flavoring agent may be sprayed to the filter portion 540, or a separate fiber coated with a flavoring agent may be inserted into the filter portion 540.

In addition, the filter portion 540 may include at least one capsule. Here, the capsule may perform a function of generating a flavor. For example, the capsule may be a structure that encapsulates a liquid containing a flavoring agent with a film, and may have a spherical or cylindrical shape. However, the disclosure is not limited thereto.

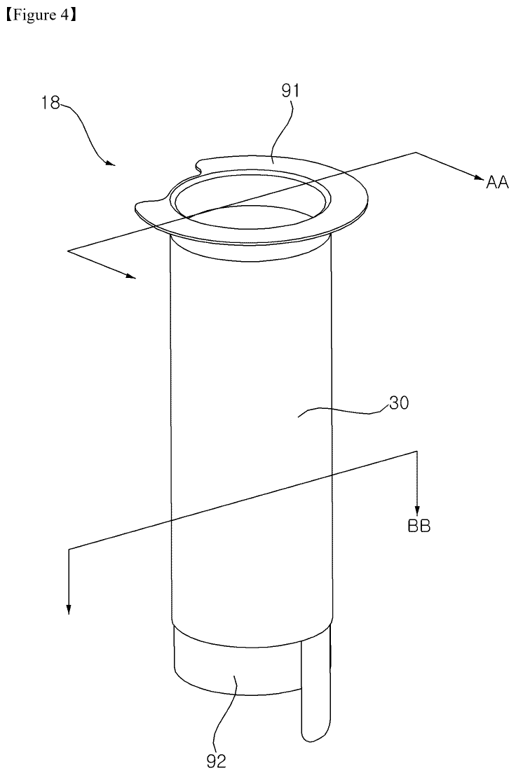

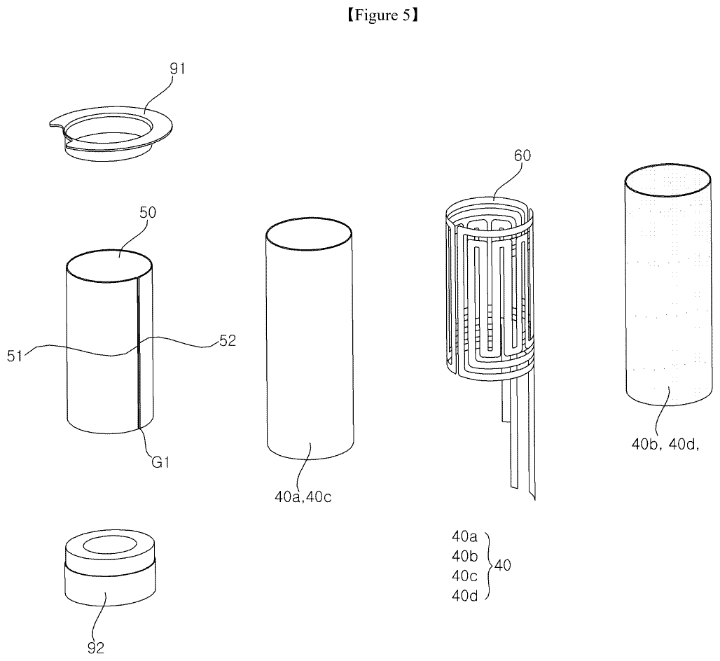

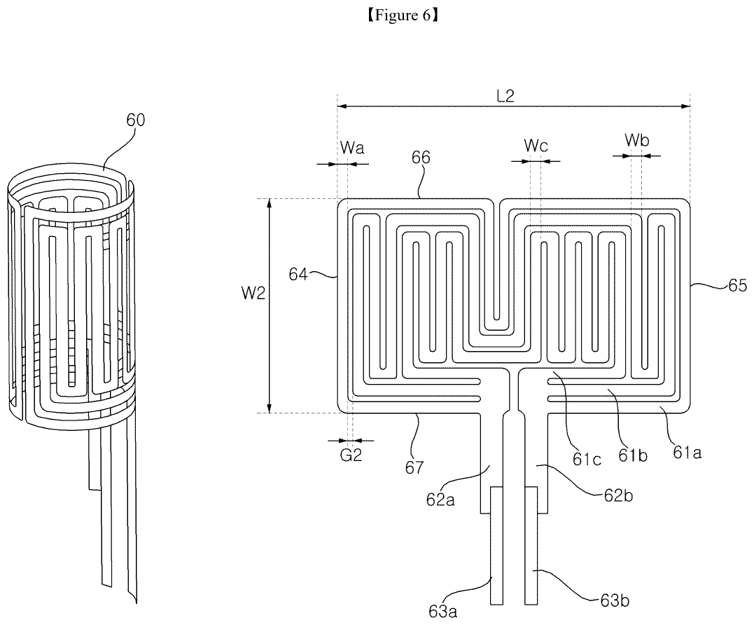

FIG. 4 is a front perspective view of a heater assembly according to an embodiment of the present disclosure, FIG. 5 is an exploded perspective view of the heater assembly according to the embodiment of the present disclosure, and FIG. 6 is a view showing a heating element of the heater assembly according to the embodiment of the present disclosure. Referring to FIG. 4, the heater 18 may include a heater assembly 30. The heater assembly 30 may be elongated. The heater assembly 30 may have a tubular shape or a cylindrical shape including a cavity formed therein. The heater assembly 30 may be disposed in the body 10 of the aerosol-generating device 1. The heater assembly 30 may surround the insertion space 43 (refer to FIGS. 1, 2, 7). The heater assembly 30 may provide the insertion space 43. The insertion space 43 or the stick S inserted into the insertion space 43 may be heated by the heater assembly 30. The heater assembly 30 may include a pair of leads 63a and 63b (refer to FIG. 6) that protrude outwardly and are electrically connected to the power supply 11.

The heater 18 may include a pair of brackets 91 and 92. The pair of brackets 91 and 92 may be coupled to the top and bottom of the heater assembly 30, respectively. The pair of brackets 91 and 92 may be coupled to the heater assembly 30 to support the heater assembly 30.

Referring to FIGS. 5 and 6, the heater assembly 30 may include an insulator 40, a susceptor 50, and a heating element 60.

The susceptor 50 may have a cylindrical shape in which a thin-film-type metal sheet is rolled up. The susceptor 50 may be referred to as a heat conductor, a heat conducting part, or a pipe. The susceptor 50 may be made of stainless steel, aluminum, or an alloy thereof without being limited thereto.

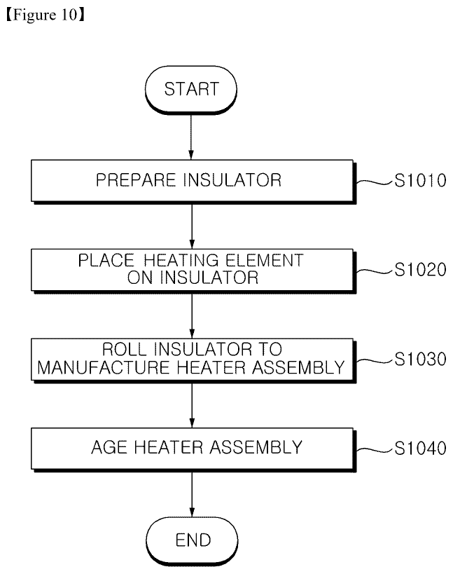

The thin-film-type metal sheet may have a rectangular shape that is elongated in one direction such that the length L1 thereof (refer to FIG. 10) is greater than the width W1 thereof (refer to FIG. 10). The length and width of the thin-film-type metal sheet may be defined as the length and width of the susceptor 50, respectively.

One end 51 of the susceptor 50 may be spaced apart from the other end 52 of the susceptor 50 in the peripheral direction of the susceptor 50 or the peripheral direction of the insertion space 43. A gap G1 may be formed between one end 51 and the other end 52 of the susceptor. As the width of the gap G1 increases, the area of a portion of the stick S that is not heated due to the gap G1 may increase. Therefore, the width of the gap G1 may correspond to an upper limit width at which an aerosol is generated from the stick S in a preset minimum required amount or more.

Accordingly, it may be possible to prevent a phenomenon that the shape of the susceptor 50 is distorted or parts of the susceptor 50 overlap each other due to errors in the assembly process when the thin-film-type sheet is rolled to form the cylindrical shape of the susceptor 50.

The heating element 60 may have a rolled-cylindrical shape. The heating element 60 may be an electrically conductive track. The heating element 60 may be formed by etching a thin metal film using a laser. The heating element 60 may generate heat in response to power received from the power supply 11.

The heating element 60 may be made of stainless steel, aluminum, or an alloy thereof without being limited thereto.

The heating element 60 may have a rectangular shape that is elongated in one direction such that the length L2 thereof is greater than the width W2 thereof. The heating element 60 may include a heat-generating track 61 and a connection portion 62. The heat-generating track 61 may include one or more tracks 61a, 61b, and 61c. The first track 61a may be disposed at the outermost portion of the heating element 60 and may have a rectangular shape overall. The second track 61b may be disposed inside the first track 61a, and the third track 61c may be disposed inside the second track 61b.

Each of the first to third tracks 61a, 61b, and 61c may include at least one bent portion and may have a serpentine shape. The first to third tracks 61a, 61b, and 61c may be spaced apart from each other. One end of each of the first to third tracks 61a, 61b, and 61c may be connected to one end of each of the other tracks, and the other end of each of the first to third tracks 61a, 61b, and 61c may be connected to the other end of each of the other tracks. In other words, the first to third tracks 61a, 61b, and 61c may be connected in parallel to each other.

The width Wa of the first track 61a may be less than the width Wb of the second track 61b and the width Wc of the third track 61c. The width Wb of the second track 61b may be less than the width Wc of the third track 61c. A gap G2 by which the second track 61b is spaced apart from the first track 61a or the third track 61c may be less than the width Wa of the first track 61a, the width Wb of the second track 61b, and the width Wc of the third track 61c. The length of the first track 61a may be less than the length of the second track 61b and the length of the third track 61c.

Accordingly, resistance deviation between the first track 61a disposed at the outermost portion of the heating element 60, the second track 61b disposed inside the first track 61a, and the third track 61c disposed inside the second track 61b may be reduced, and deviation between the amounts of heat generated from the respective tracks may be reduced.

In addition, because the gap between the tracks is less than the widths of the tracks, the heat-generating area of the heating element 60 may be increased, and the insertion space 43 or the stick S inserted into the insertion space 43 may be evenly heated by the heating element 60.

The connection portion 62 may protrude outwardly from one side of the heat-generating track 61. The connection portion 62 may be integrally formed with the heat-generating track 61. The connection portion 62 may include a first connection portion 62a and a second connection portion 62b. The first connection portion 62a may be connected to one end of each of the first to third tracks 61a, 61b, and 61c, and the second connection portion 62b may be connected to the other end of each of the first to third tracks 61a, 61b, and 61c.

The lead 63 may be connected to the connection portion 62. The lead 63 may be elongated in the direction in which the connection portion 62 protrudes. The lead 63 may electrically connect the connection portion 62 to the power supply 11 or a heater driving circuit (not shown). The lead 63 may include a first lead 63a in contact with the first connection portion 62a and a second lead 63b in contact with the second connection portion 62b. The lead 63 may be made of a material having a lower temperature coefficient of resistance (TCR) than the heating element 60. The lead 63 may be attached to the connection portion 62 through welding, but the disclosure is not limited thereto.

Accordingly, change in the temperature of the heating element 60 obtained based on the change in the resistance of the heating element 60 may be accurately measured.

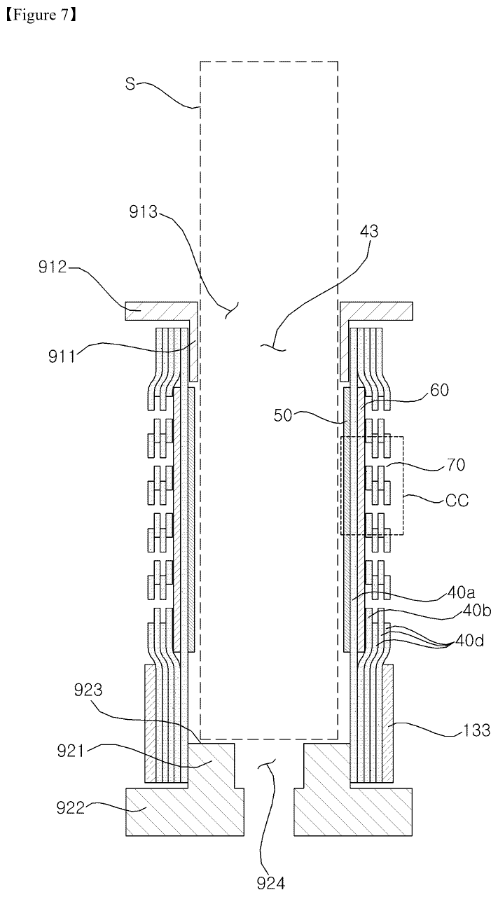

FIG. 7 is a cross-sectional view of the heater assembly according to the embodiment of the present disclosure.

Referring to FIG. 7, the susceptor 50 may be located at the innermost portion of the heater assembly 30. The insertion space 43 may be disposed inside the susceptor 50. The susceptor 50 may define at least a portion of the insertion space 43. The susceptor 50 may surround at least a portion of the insertion space 43. The inner circumferential surface of the susceptor 50 may be exposed to the insertion space 43. The susceptor 50 may face the stick S inserted into the insertion space 43. At least a portion of the inner circumferential surface of the susceptor 50 may be in contact with the outer circumferential surface of the stick S inserted into the insertion space 43.

Accordingly, the thin-film-type susceptor defines at least a portion of the insertion space and is in direct contact with the stick inserted into the insertion space, thereby increasing efficiency of transfer of heat to the stick.

A portion of the insulator 40 may surround the outer side of the heating element 60. A portion of the insulator 40 may be disposed between the heating element 60 and the susceptor 50.

The susceptor 50 and the heating element 60 may be spaced apart from the upper end and the lower end of the insulator 40. In the heater assembly 30, some of multiple layers forming the insulator 40 may be in contact with each other at upper and lower end portions thereof in the longitudinal direction of the insertion space 43.

A first part 40a of the insulator 40, which is disposed inside the heating element 60, and a second part 40b of the insulator 40, which is disposed outside the heating element 60, may be in contact with each other at upper and lower end portions thereof. The heating element 60 may be sealed from the outside due to the structure in which the upper and lower end portions of the first part 40a and the upper and lower end portions of the second part 40b are in contact with each other.

The hollow heater assembly 30 may be combined with the brackets 91 and 92. The brackets 91 and 92 may be bonded to or press-fitted into the heater assembly 30. In the state in which the hollow heater assembly 30 is combined with the brackets 91 and 92, the heater assembly 30 and the brackets 91 and 92 may be heated to a predetermined temperature or higher.

Accordingly, the heater assembly may be sealed from the outside, and release of heat generated from the electrically conductive pattern to the outside of the heater assembly may be minimized.

An insertion hole 913 in the first bracket 91 may communicate with an upper side of the insertion space 43. A hole 924 in the second bracket 92 may communicate with a lower side of the insertion space 43. The stick S may be inserted into the insertion space 43 through the insertion hole 913. Outside air may flow into the stick S via an end portion of the stick S through the hole 924 from the outside of the heater assembly 30.

A first bracket body 911 of the first bracket 91 may extend in the peripheral direction. The first bracket body 911 may be attached to or press-fitted into the upper end portion of the heater assembly 30. The inner circumferential surface of the first bracket body 911 may support at least a portion of the outer circumferential surface of the stick S inserted into the insertion space 43. A first flange 912 may protrude from the upper end portion of the first bracket body 911 in the radially outward direction.

A second bracket body 921 of the second bracket 92 may extend in the peripheral direction. The second bracket body 921 may be attached to or press-fitted into the lower end portion of the heater assembly 30. The upper surface 923 of the second bracket body 921 may support at least a portion of the lower end of the stick S inserted into the insertion space 43. A second flange 922 may protrude from the lower end portion of the second bracket body 921 in the radially outward direction.

The first bracket 91 and the second bracket 92 may be spaced apart from the susceptor 50 in the longitudinal direction of the insertion space 43. In the longitudinal direction of the insertion space 43, the lower end of the first bracket body 911 may be spaced apart from the upper end 53 of the susceptor 50, and the upper end of the second bracket body 921 may be spaced apart from the lower end 54 of the susceptor 50.

A stick detection sensor 133 may be disposed in the heater assembly 30. The stick detection sensor 133 may detect insertion and/or removal of the stick S. For example, the stick detection sensor 133 may be an inductive sensor and/or a capacitance sensor. The stick detection sensor 133 may be disposed adjacent to the lower end of the insertion space 43. The stick detection sensor 133 may be disposed so as to surround at least a portion of the lower side of the heater assembly 30. The stick detection sensor 133 may be disposed so as to be in contact with the outermost layer of the insulator 40 and to surround the outermost layer. The stick detection sensor 133 may be disposed below the susceptor 50 and the heating element 60 in the longitudinal direction of the insertion space 43. The stick detection sensor 133 may be spaced apart from the susceptor 50 and the heating element 60 in the longitudinal direction of the insertion space 43.

Accordingly, transfer of heat generated by the susceptor 50 and the heating element 60 to the sensor 133 may be minimized. In addition, the accuracy of detection of the stick S by the sensor 133 may be increased.

The insulator 40 may surround the inner side and/or outer side of the heating element 60. The insulator 40 may form multiple layers 40a, 40b, and 40d in the radial direction of the insertion space 43 or in the thickness direction of the insulator 40. The multiple layers 40a, 40b, and 40d of the insulator 40 may be formed by rolling one elongated insulating sheet. The multiple layers may be formed by at least one part of the insulator 40. A plurality of holes H1, H2, H3, and H4 may be formed in the multiple layers 40b and 40d of the insulator 40 that surround the outer side of the heating element 60.

The plurality of holes H1, H2, H3, and H4 may communicate with each other. The plurality of holes H1, H2, H3, and H4 may overlap each other to form a through-hole 70. The through-hole 70 may be formed by overlapping the holes formed in the multiple layers 40b and 40d of the insulator 40. The through-hole 70 may penetrate the multiple layers 40b and 40d.

Due to the through-hole 70 penetrating the insulator 40 disposed outside the heating element 60, voids generated in the insulator 40 may be discharged outside the insulator 40, and lifting or delamination of the layers forming the insulator 40 may be prevented.

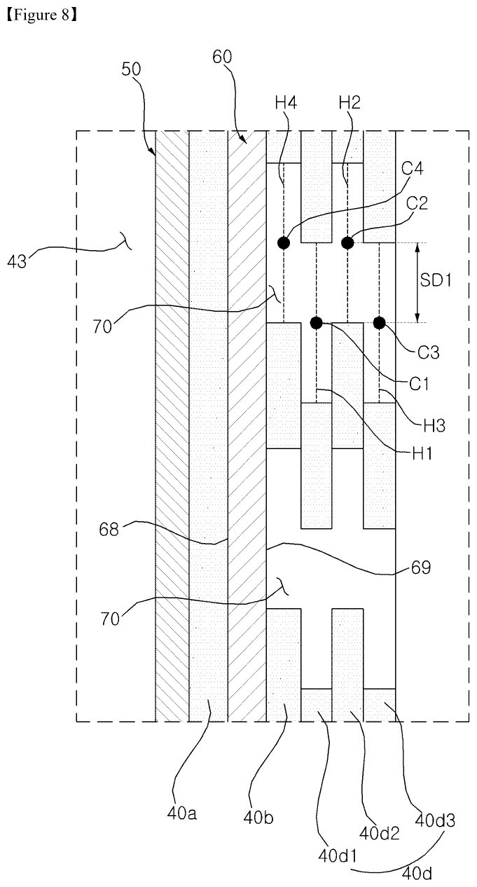

FIG. 8 is a cross-sectional view showing the through-hole in the heater assembly according to the embodiment of the present disclosure.

Referring to FIG. 8, the multiple layers 40b and 40d of the insulator 40 may include a first layer 40d1 disposed outside the heating element 60 in the radial direction of the insertion space 43, a second layer 40d2 disposed outside the first layer 40d1 while being in contact with the first layer 40d1, a third layer 40d3 disposed outside the second layer 40d2 while being in contact with the second layer 40d2, and a fourth layer 40b disposed inside the first layer 40d1 while being in contact with an outer surface 69 of the heating element 60 and the first layer 40d1. However, the number of layers of the insulator 40 that are disposed outside the heating element 60 is not limited thereto, and two or more layers may be formed.

A plurality of first holes H1 may be formed in the first layer 40d1. A plurality of second holes H2 may be formed in the second layer 40d2. A plurality of third holes H3 may be formed in the third layer 40d3. A plurality of fourth holes H4 may be formed in the fourth layer 40b. In the radial direction of the insertion space 43, the plurality of first holes H1 may be located farther inward than the plurality of second holes H2. The plurality of second holes H2 may be located farther inward than the plurality of third holes H3. The plurality of fourth holes H4 may be located farther inward than the plurality of first holes H1.

At least some of the holes H1, H2, H3, and H4 forming the through-hole 70 may be disposed such that the centers thereof are misaligned from the centers of holes adjacent thereto in the radial direction of the insertion space 43. For example, the center C4 of the fourth hole H4 formed in the fourth layer 40b may be misaligned from the center C1 of the first hole H1 formed in the first layer 40d1. For example, the center C1 of the first hole H1 formed in the first layer 40d1 may be misaligned from the center C2 of the second hole H2 formed in the second layer 40d2. For example, the center C2 of the second hole H2 formed in the second layer 40d2 may be misaligned from the center C3 of the third hole H3 formed in the third layer 40d3.

Because the holes H1, H2, H3, and H4 forming the through-hole 70 communicate with each other and the centers thereof are misaligned from each other, the layers in which the holes H1, H2, H3, and H4 are formed may be disposed so as to be misaligned from each other to a certain extent. An area of the inner surface and/or outer surface of each of the layers that is exposed to the inside of the through-hole 70 may increase in proportion to the extent to which the layers in which the holes H1, H2, H3, and H4 are formed are misaligned from each other.

Accordingly, voids generated in each of the layers of the insulator may be effectively discharged outside through the portion exposed to the inside of the through-hole 70.

The centers of the holes H1, H2, H3, and H4 forming the through-hole 70 may be spaced apart from each other within a predetermined range. The centers of the holes H1, H2, H3, and H4 disposed in adjacent layers while forming the through-hole 70 may be spaced apart from each other by a distance less than the sum of the radii of the holes. For example, a distance by which the center C4 of the fourth hole H4 is spaced apart from the center C1 of the first hole H1 may be less than the sum of the radius Rh4 of the fourth hole H4 and the radius Rh1 of the first hole H1. For example, a distance SD1 by which the center C2 of the second hole H2 is spaced apart from the center C1 of the first hole H1 may be less than the sum of the radius Rh2 of the second hole H2 and the radius Rh1 of the first hole H1. For example, a distance by which the center C3 of the third hole H3 is spaced apart from the center C2 of the second hole H2 may be less than the sum of the radius Rh3 of the third hole H3 and the radius Rh2 of the second hole H2.

Accordingly, the holes H1, H2, H3, and H4 disposed in adjacent layers may be disposed so as to be partially misaligned from each other and thus may communicate with each other to form the through-hole 70.

The centers of the holes H1, H2, H3, and H4 disposed in adjacent layers while forming the through-hole 70 may be spaced apart from each other by a distance greater than the average of the radii of the holes. For example, the distance by which the center C4 of the fourth hole H4 is spaced apart from the center C1 of the first hole H1 may be greater than the average of the radius Rh4 of the fourth hole H4 and the radius Rh1 of the first hole H1. For example, the distance SD1 by which the center C2 of the second hole H2 is spaced apart from the center C1 of the first hole H1 may be greater than the average of the radius Rh2 of the second hole H2 and the radius Rh1 of the first hole H1. For example, the distance by which the center C3 of the third hole H3 is spaced apart from the center C2 of the second hole H2 may be greater than the average of the radius Rh3 of the third hole H3 and the radius Rh2 of the second hole H2.

If the centers of the holes H1, H2, H3, and H4 disposed in adjacent layers are not spaced apart from each other by a predetermined distance or longer, the area of the inner surface and/or outer surface of each of the layers that is exposed to the inside of the through-hole 70 may decrease, and the amount of outside air introduced into the through-hole 71 may increase. In this case, the amount of heat generated from the heating element 60 that is released outside through the through-hole 70 may increase, and thus the amount of heat transferred to the insertion space 43 and/or the stick S inserted into the insertion space 43 may decrease.

In the heater assembly 30 according to the embodiment of the present disclosure, because the centers of the holes H1, H2, H3, and H4 disposed in adjacent layers are spaced apart from each other by a predetermined distance or longer, the amount of heat generated from the heating element 60 that is released outside through the through-hole 70 may be reduced.

The distances by which the centers of the holes H1, H2, H3, and H4 disposed in adjacent layers while forming the through-hole 70 are spaced apart from each other may be identical. For example, the distance by which the center C1 of the first hole H1 is spaced apart from the center C4 of the fourth hole H4, the distance SD1 by which the center C2 of the second hole H2 is spaced apart from the center C1 of the first hole H1, and the distance by which the center C3 of the third hole H3 is spaced apart from the center C2 of the second hole H2 may be identical.

Accordingly, the areas of the inner surfaces and/or outer surfaces of the respective layers that are exposed to the inside of the through-hole 70 may be identical or similar to each other, whereby voids generated in each of the layers of the insulator may be effectively discharged outside.

The through-hole 70 may extend in the radial direction of the insertion space 43. The through-hole 70 may allow the outer surface 69 of the heating element 60 to communicate with the outside of the insulator 40.

The layer 40b in contact with the outer surface 69 of the heating element 60 may be heated to a higher temperature by the heating element 60 than the remaining layers 40d1, 40d2, and 40d3 disposed outside the heating element 60. Therefore, more voids may be generated in the inner surface of the layer 40b that is in contact with the outer surface 69 of the heating element 60.

In the heater assembly 30 according to the embodiment of the present disclosure, because the through-hole 70 allows the outer surface 69 of the heating element 60 to communicate with the outside of the insulator 40, voids generated in the inner surface of the layer 40b that is in contact with the outer surface 69 of the heating element 60 may be effectively discharged outside.

The diameter or radius Rh4 of the hole H4 formed in the layer 40b in contact with the outer surface 69 of the heating element 60 may be less than the diameters or radii Rh1, Rh2, and Rh3 of the holes H1, H2, and H3 formed in the remaining layers 40d1, 40d2, and 40d3 disposed outside the heating element 60.

Because the hole H4 formed in the layer 40b in contact with the outer surface 69 of the heating element 60 has a smaller diameter or radius than the holes H1, H2, and H3 formed in the remaining layers 40d1, 40d2, and 40d3, the amount of heat generated from the heating element 60 that is released outside through the through-hole 70 may be reduced.

The through-hole 70 may be provided in plural. The through-hole 70 may include a plurality of through-holes 70 spaced apart from each other in the longitudinal direction of the insertion space 43. For example, five to seven through-holes 70 may be aligned in the longitudinal direction of the insertion space 43.

The through-hole 70 may include a plurality of through-holes 70 spaced apart from each other in the peripheral direction of the insertion space 43. For example, eight to twelve through-holes 70 may be aligned in the peripheral direction of the insertion space 43.

However, the number of through-holes 70 aligned in the longitudinal direction and/or peripheral direction of the insertion space 43 is not limited thereto.

Because the plurality of through-holes 70 is aligned in the longitudinal direction and/or peripheral direction of the insertion space 43, even if voids are generated at various different positions in the multiple layers forming the insulator 40, the generated voids may be effectively discharged outside through the plurality of through-holes 70.

At least some of the plurality of through-holes 70 may be disposed so as to overlap the susceptor 50 and the heating element 60 in the radial direction of the insertion space 43.

In the radial direction of the insertion space 43, the portion of the insulator 40 that overlaps the susceptor 50 and the heating element 60 may be heated to a higher temperature than the non-overlapping portion thereof. Therefore, more voids may be generated in the overlapping portion of the insulator 40.

In the heater assembly 30 according to the embodiment of the present disclosure, because the through-hole 70 is disposed so as to overlap the susceptor 50 and the heating element 60, voids generated in the insulator 40 may be effectively discharged outside.

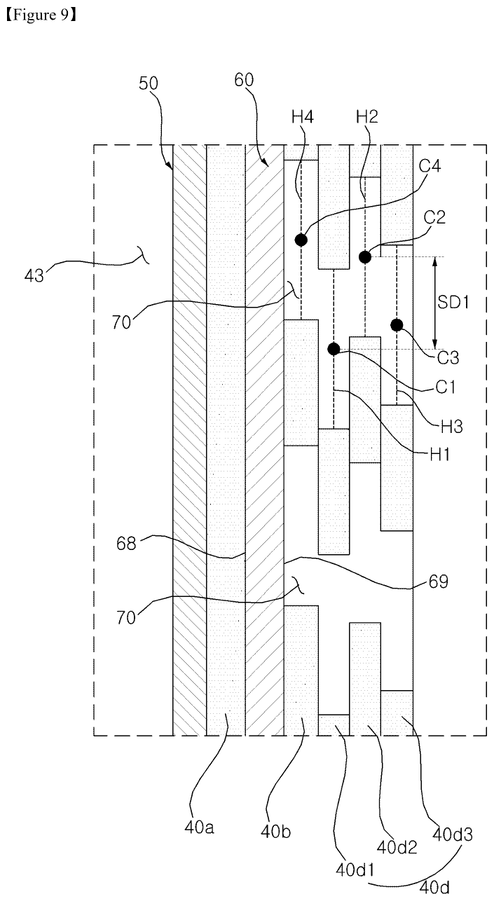

FIG. 9 is a cross-sectional view showing a through-hole of a heater assembly according to an embodiment of the present disclosure. A detailed description of the features of the through-hole identical to those of the through-hole shown in FIG. 8 will be omitted.

Referring to FIG. 9, at least some of the holes H1, H2, H3, and H4 forming the through-hole 70 may be disposed such that the centers thereof are misaligned from the centers of holes adjacent thereto in the radial direction of the insertion space 43. The distances by which the centers of the holes H1, H2, H3, and H4 disposed in adjacent layers while forming the through-hole 70 are spaced apart from each other may be different. For example, the distance by which the center C1 of the first hole H1 is spaced apart from the center C4 of the fourth hole H4, the distance SD1 by which the center C2 of the second hole H2 is spaced apart from the center C1 of the first hole H1, and the distance by which the center C3 of the third hole H3 is spaced apart from the center C2 of the second hole H2 may be different.

The distances by which the centers of the holes H1, H2, H3, and H4 disposed in adjacent layers while forming the through-hole 70 are spaced apart from each other may gradually decrease as the holes are located farther outward in the radial direction of the insertion space 43. For example, the distance SD1 by which the center C2 of the second hole H2 is spaced apart from the center C1 of the first hole H1 may be less than or equal to the distance by which the center C1 of the first hole H1 is spaced apart from the center C4 of the fourth hole H4. For example, the distance by which the center C3 of the third hole H3 is spaced apart from the center C2 of the second hole H2 may be less than or equal to the distance SD1 by which the center C2 of the second hole H2 is spaced apart from the center C1 of the first hole H1.

A layer disposed relatively close to the heating element 60 may be heated to a higher temperature by the heating element 60 than a layer disposed relatively far from the heating element 60. Therefore, more voids may be generated in the inner surface of the layer disposed relatively close to the heating element 60 than in the inner surface of the layer disposed relatively far from the heating element 60.

In the heater assembly 30 according to the embodiment of the present disclosure, the distances by which the centers of the holes H1, H2, H3, and H4 disposed in adjacent layers while forming the through-hole 70 are spaced apart from each other may gradually decrease as the holes are located farther outward in the radial direction of the insertion space 43. In this case, in the layer disposed relatively close to the heating element 60, the area of the inner surface and/or outer surface thereof that is exposed to the inside of the through-hole 70 may be larger than in the layer disposed relatively far from the heating element 60. In addition, the amount of outside air introduced into the layer disposed relatively close to the heating element 60 may be smaller than the amount of outside air introduced into the layer disposed relatively far from the heating element 60.

Accordingly, voids generated in the layer disposed close to the heating element 60 may be effectively discharged outside. In addition, the amount of heat generated from the heating element 60 that is released outside through the through-hole 70 may be reduced.

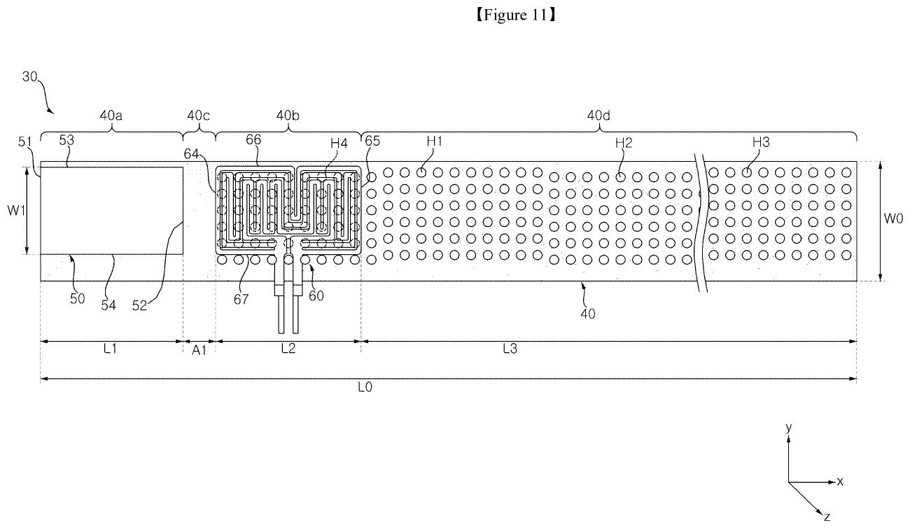

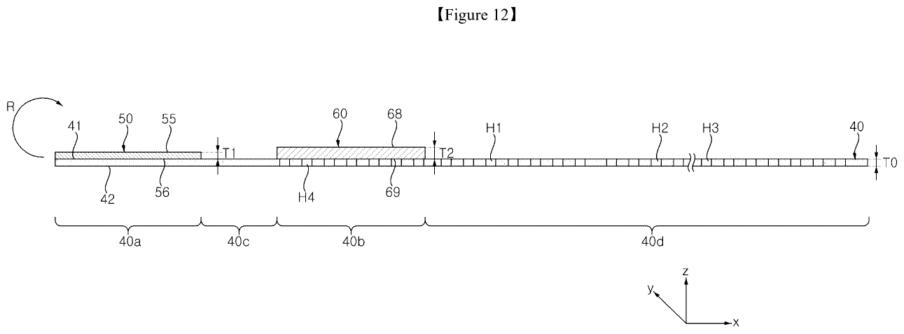

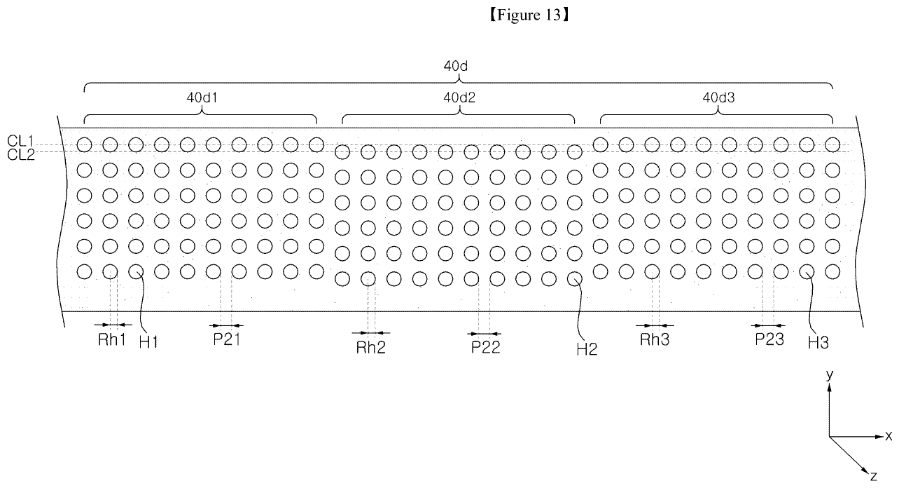

FIG. 10 is a flowchart showing a method of manufacturing the heater assembly according to an embodiment of the present disclosure, FIGS. 11 and 12 are views showing an unfolded state of the heater assembly according to the embodiment of the present disclosure, and FIG. 13 is a view showing the holes in the insulator of the heater assembly according to the embodiment of the present disclosure.

Referring to FIG. 10, the method of manufacturing the heater assembly according to the embodiment of the present disclosure may include a step of preparing the insulator 40 (S1010), a step of placing the heating element 60 on the insulator 40 (S1020), a step of rolling the insulator 40 with the heating element 60 placed thereon to manufacture the heater assembly 30 (S1030), and a step of aging the heater assembly 30 (S1040).

In step S1010, the insulator 40 formed to elongated may be prepared. The insulator 40 may be in the shape of a single sheet elongated in one direction or in the x direction. The insulator 40 may be referred to as a sheet or an insulating sheet. The sheet 40 may be a flexible sheet, and may be formed of a heat-resistant material. The sheet 40 may include, but is not limited to, polyimide or polyetheretherketone (PEEK), and may include other materials having elasticity, heat resistance, and electrical insulation.

The length L0 of the sheet 40 may be 120 mm to 160 mm, and the width W0 of the sheet 40 may be 15 mm to 25 mm. In some embodiments, the length L0 of the sheet 40 may be 130 mm to 150 mm, and the width W0 of the sheet 40 may be 17.5 mm to 22.5 mm.

Referring to FIGS. 11 to 13 together with FIG. 10, in step S1020, the heating element 60 may be placed on the sheet 40. The susceptor 50 may be placed on the sheet 40 together with the heating element 60. The susceptor 50 and the heating element 60 may be sequentially placed in the longitudinal direction of the sheet 40. The susceptor 50 and the heating element 60 may be placed so as to be spaced apart from each other in the longitudinal direction of the sheet 40.

The susceptor 50 and the heating element 60 may be placed on the same surface of the sheet 40. The sheet 40 may include a first surface 41 that is flat and a second surface 42 that is formed opposite the first surface 41 in the thickness direction thereof. The susceptor 50 and the heating element 60 may be placed on the first surface 41 of the sheet 40. The sheet 40 may be placed on a feeder (not shown). The sheet 40 may be placed on the feeder such that the second surface 42 thereof is in contact with the upper surface of the feeder.

Because the susceptor 50 and the heating element 60 are disposed on the same surface of the sheet 40, springback, which is a phenomenon occurring when an elastic object is rolled, may be reduced, and accordingly, defects in the heater assembly 30 may be reduced.

The susceptor 50 may be disposed adjacent to one end of the sheet 40 in the longitudinal direction of the sheet 40. One end 51 of the susceptor 50 may be aligned parallel to one end of the sheet 40. One end 64 of the heating element 60 may be spaced apart from the other end 52 of the susceptor 50 by a predetermined distance A1. The upper end 53 of the susceptor 50 may be aligned with the upper end 66 of the heating element 60. The lower end 54 of the susceptor 50 may be aligned with the lower end 67 of the heating element 60.

The width W0 of the sheet 40 may be greater than the width W1 of the susceptor 50 and the width W2 of the heating element 60. The susceptor 50 and the heating element 60 may be disposed so as to be spaced apart from the lower end and upper end of the sheet 40 in the width direction of the sheet 40 or in the y direction.

The distance A1 by which the susceptor 50 is spaced apart from the heating element 60 in the longitudinal direction of the sheet 40 may be less than the length L2 of the heating element 60 defined in the longitudinal direction of the sheet 40. The number of layers of the sheet 40 disposed between the susceptor 50 and the heating element 60 may be two or less.

Accordingly, heat generated from the heating element 60 may be more efficiently transferred to the susceptor 50.

In the longitudinal direction of the sheet 40, the length L2 of the heating element 60 may be greater than the length L1 of the susceptor 50. In the hollow heater assembly 30, the heating element 60 may surround the susceptor 50 outside the susceptor 50. Because the length L2 of the heating element 60 is greater than the length L1 of the susceptor 50, the area of the portion of the heating element 60 that surrounds the susceptor 50 may be increased.

Accordingly, the area of transfer of heat from the heating element 60 to the susceptor 50 may be increased, and the insertion space 43 or the stick S in the insertion space 43 may be more evenly heated by the susceptor 50 and the heating element 60. In addition, because the area of the heating element 60 is increased, freedom of design of the shape of the heat-generating track of the heating element 60 may be increased.

The sheet 40 may include first to fourth parts 40a, 40b, 40c, and 40d. The susceptor 50 may be disposed on the first part 40a. The heating element 60 may be disposed on the second part 40b. The third part 40c may be disposed between the first part 40a and the second part 40b in the longitudinal direction of the sheet 40 and may be connected to the first part 40a and the second part 40b. The fourth part 40d may extend from the second part 40b in the longitudinal direction of the sheet 40 and may be opposite the third part 40c with respect to the second part 40b.

In step S1030, the insulator 40 with the heating element 60 disposed thereon may be rolled to manufacture the heater assembly 30. The sheet 40 may be rolled around a roller (not shown). In the state in which the sheet 40 is disposed on the feeder, one end of the sheet 40 may first be rolled around the roller. The sheet 40 may be moved toward the roller by the feeder, and may be rolled around the outer circumferential surface of the roller rotating in one direction. The sheet 40 may be heated by the roller. The sheet 40 may be pressed by a sub-roller disposed adjacent to the roller.

The susceptor 50 and the heating element 60 may be rolled around the roller together with the sheet 40. The sheet 40 may be rolled around the roller so that the susceptor 50 faces the outer circumferential surface of the roller. The susceptor 50 may be rolled around the outer circumferential surface of the roller while moving together with the sheet 40 in the state of being disposed on the sheet 40. The sheet 40 may be rolled around the roller so that the heating element 60 faces the outer circumferential surface of the roller. The heating element 60 may be rolled around the roller while moving together with the sheet 40 in the state of being disposed on the sheet 40. The heating element 60 may be rolled around the outer side of the susceptor 50. The susceptor 50 and the heating element 60 may be heated and pressed by the roller and the sub-roller, and may thus be thermally fused to the sheet 40.

Accordingly, the process of manufacturing the heater assembly 30 may be simplified, and the bonding structure of the heater assembly 30 may be simplified.

In step S1030, as the sheet 40 is rolled, the plurality of holes H1, H2, H3, and H4 formed in the sheet 40 may overlap each other outside the heating element 60. The plurality of holes H1, H2, H3, and H4 formed in the sheet 40 may penetrate the sheet 40 in the thickness direction of the sheet 40. The holes H1, H2, H3, and H4 formed in the multiple layers formed outside the heating element 60 may overlap and communicate with each other to form the through-hole 70. In the radial direction of the insertion space 43, the fourth hole H4 may be disposed outside the heating element 60. The first hole H1 may be disposed outside the fourth hole H4 and may communicate with the fourth hole H4. The second hole H2 may be disposed outside the first hole H1 and may communicate with the first hole H1. The third hole H3 may be disposed outside the second hole H2 and may communicate with the second hole H2.

In the unfolded state of the sheet 40, the plurality of holes H1, H2, H3, and H4 formed in the sheet 40 may be spaced apart from each other in the longitudinal direction and width direction of the sheet 40. The plurality of holes H1, H2, H3, and H4 may be disposed in rows and columns.

For example, the plurality of fourth holes H4 formed in the second part 40b of the sheet 40 may be aligned with each other in at least one row in the longitudinal direction of the sheet 40. The plurality of first holes H1 formed in the fourth part 40d of the sheet 40 may be aligned with each other in at least one row in the longitudinal direction of the sheet 40. The plurality of second holes H2 formed in the fourth part 40d of the sheet 40 may be aligned with each other in at least one row in the longitudinal direction of the sheet 40. The plurality of third holes H3 formed in the fourth part 40d of the sheet 40 may be aligned with each other in at least one row in the longitudinal direction of the sheet 40.

In the rolled state of the sheet 40, the plurality of fourth holes H4 may be aligned with each other in at least one row in the peripheral direction of the insertion space 43. The plurality of first holes H1 may be aligned with each other in at least one row in the peripheral direction of the insertion space 43. The plurality of second holes H2 may be aligned with each other in at least one row in the peripheral direction of the insertion space 43. The plurality of third holes H3 may be aligned with each other in at least one row in the peripheral direction of the insertion space 43.

The plurality of first holes H1 may be disposed in rows and columns in the second part 40b of the sheet 40. The plurality of second holes H2 may be disposed in rows and columns in a predetermined region 40d1 of the fourth part 40d of the sheet 40. The plurality of second holes H2 may be disposed in rows and columns in a predetermined area 40d2 of the fourth part 40d of the sheet 40. The plurality of third holes H3 may be disposed in rows and columns in a predetermined region 40d3 of the fourth part 40d of the sheet 40.

The plurality of first holes H1 may be disposed closer to the susceptor 50 and/or the heating element 60 than the plurality of second holes H2. The plurality of second holes H2 may be disposed closer to the susceptor 50 and/or the heating element 60 than the plurality of third holes H3. The plurality of fourth holes H4 may be disposed so as to overlap the heating element 60 in the thickness direction of the sheet 40.

The plurality of holes H1, H2, H3, and H4 may be formed by punching the sheet 40 using a punching device or the like in the state in which the sheet 40 is unfolded flat. The plurality of holes H1, H2, H3, and H4 may be formed so as to be spaced apart from each other by set intervals. For example, an interval P21 between the plurality of first holes H1 in the longitudinal direction of the sheet 40 may be constant. An interval P22 between the plurality of second holes H2 in the longitudinal direction of the sheet 40 may be constant. An interval P23 between the plurality of third holes H3 in the longitudinal direction of the sheet 40 may be constant. An interval between the plurality of fourth holes H4 in the longitudinal direction of the sheet 40 may be constant. The interval P21 between the first holes H1 may be less than or equal to the interval P22 between the second holes H2. The interval P22 between the second holes H2 may be less than or equal to the interval P23 between the third holes H3. The interval between the fourth holes H4 may be less than or equal to the interval between the first holes H1.

The holes H1, H2, H3, and H4 disposed in adjacent layers while forming the through-hole 70 may be disposed such that the centers thereof are misaligned from each other. The rows of holes H1, H2, H3, and H4 disposed in adjacent layers may be disposed so as to be misaligned from each other in the peripheral direction of the insertion space 43. For example, at least one row CL1 of the plurality of first holes H1 may be disposed so as to be misaligned from at least one row CL2 of the plurality of second holes H2 in the longitudinal direction of the sheet 40 or the peripheral direction of the insertion space 43. The at least one row CL2 of the plurality of second holes H2 may be disposed so as to be misaligned from at least one row of the plurality of third holes H3 in the longitudinal direction of the sheet 40 or the peripheral direction of the insertion space 43. At least one row of the plurality of fourth holes H4 may be disposed so as to be misaligned from the at least one row CL1 of the plurality of first holes H1 in the longitudinal direction of the sheet 40 or the peripheral direction of the insertion space 43.

Accordingly, by adjusting the arrangement intervals between the holes H1, H2, H3, and H4 formed in the sheet 40, it may be possible to easily form the through-hole 70 in which the centers of the holes H1, H2, H3, and H4 are misaligned from each other.

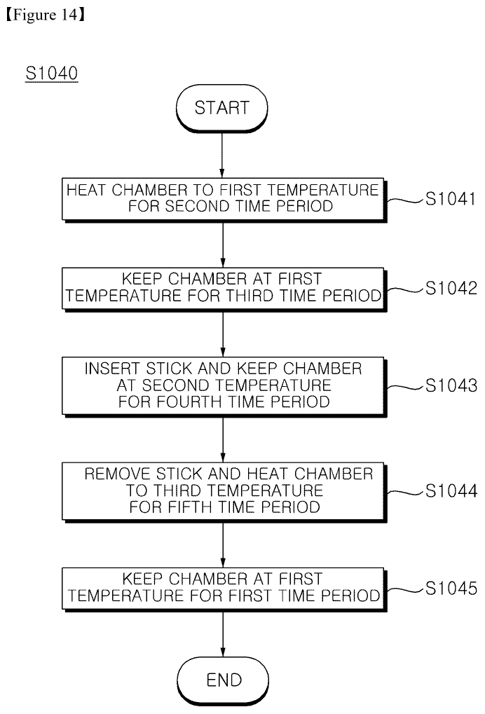

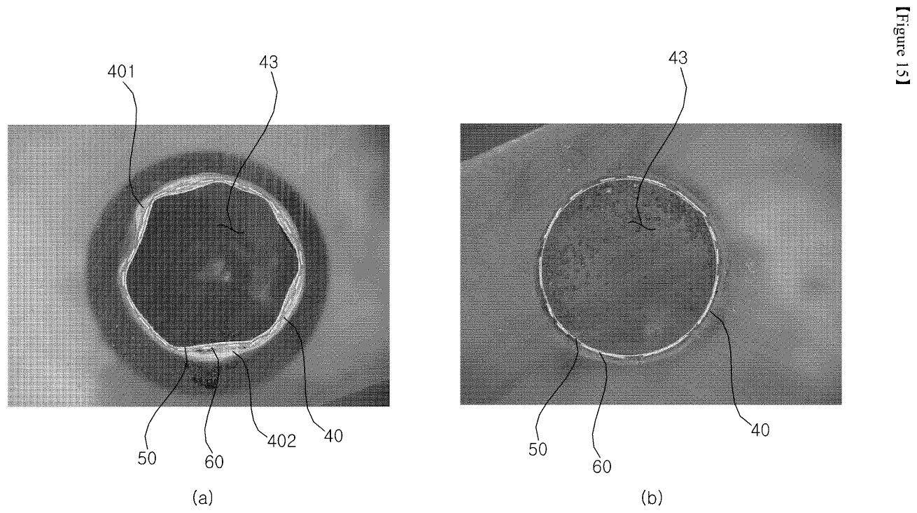

FIG. 14 is a flowchart showing a step of aging the heater assembly according to an embodiment of the present disclosure, and FIG. 15 shows comparison images of a conventional heater assembly and the heater assembly aged according to the heater assembly manufacturing method of the embodiment of the present disclosure.

Referring to FIG. 15 together with FIG. 14, the heater assembly 30 may be aged in step S1040. Step S1040 of aging the heater assembly 30 may include a step of heating a chamber (not shown) containing the heater assembly 30 to a first temperature for a second time period shorter than a first time period (S1041), a step of keeping the chamber at the first temperature for a third time period longer than the second time period (S1042), a step of inserting a stick S into the heater assembly 30 and keeping the chamber at a second temperature lower than the first temperature for a fourth time period longer than the third time period (S1043), a step of removing the stick S from the heater assembly 30 and heating the chamber to a third temperature for a fifth time period shorter than the fourth time period (S1044), and a step of keeping the chamber at the first temperature for the first time period (S1045).

In step S1041, the second time period may be 6 to 10 seconds. In some embodiments, the second time period may be about 8 seconds. The first temperature may be 280° C. to 300° C. In some embodiments, the first temperature may be about 290° C.

In step S1042, the third time period may be 20 to 24 seconds. In some embodiments, the third time period may be about 22 seconds.

In step S1043, the fourth time period may be 300 to 320 seconds. In some embodiments, the fourth time period may be about 310 seconds. The second temperature may be 240° C. to 260° C. In some embodiments, the second temperature may be about 250° C.

In step S1044, the fifth time period may be 5 to 7 seconds. In some embodiments, the fifth time period may be about 6 seconds. The third temperature may be 285° C. to 305° C. In some embodiments, the third temperature may be about 295° C. Alternatively, in step S1044, the chamber may be heated with first power for the fifth time period. The first power may be 10 W to 20 W. In some embodiments, the first power may be about 15 W.

In step S1045, the first time period may be 3 to 5 hours. In some embodiments, the first time period may be about 4 hours.

Referring to FIG. 15, the left image shows the cross-section of the conventional heater assembly cut in the radial direction of the insertion space after being left under a set condition, and the right image shows the cross-section of the heater assembly cut in the radial direction of the insertion space after being aged according to the heater assembly manufacturing method of the embodiment of the present disclosure and then left under the same condition. The set condition is a condition in which the heater assembly is left in an environment with a temperature of 60° C. and humidity of 90% for 16 hours. However, this set condition is an example for comparing the degree of swelling or lifting of the insulator between the conventional heater assembly and the heater assembly aged according to the manufacturing method of the embodiment of the present disclosure, and may be variously changed as needed.

Referring to the left image in FIG. 15, in the peripheral direction of the heater assembly, swelling occurred in various portions 401 and 402 of the insulator 40, and a portion of the insulator 40 was lifted from the susceptor 50 and/or the heating element 60. As a result, it can be seen that the shape of the susceptor 50 and/or the heating element 60 was distorted and the insertion space 43 was deformed.

In contrast, in the case of the heater assembly 30 aged according to the manufacturing method of the embodiment of the present disclosure, swelling did not occur in the insulator 40, and no portion of the insulator 40 was lifted from the susceptor 50 and/or the heating element 60. As a result, it can be seen that the shape of the insertion space 43 is maintained as is without being distorted.

As described above, according to the embodiment of the present disclosure, because the heater assembly is aged based on a heating time and a heating temperature set within predetermined ranges, it may be possible to prevent the insulator from swelling or prevent a portion of the insulator from being lifted or delaminated from the susceptor and/or the heating element with the use of the aerosol-generating device.

In general, problems such as lifting or delamination of the insulator may not occur immediately after the heater assembly is manufactured and aged. However, when a reliability test is conducted later or the aerosol-generating device is sold and used by a user, the heater assembly may be damaged due to voids generated in the insulator of the heater assembly. According to the method of manufacturing the heater assembly according to the embodiment of the present disclosure, because the heater assembly is aged for a long time period over steps S1041 to S1045 based on the heating time and the heating temperature set within predetermined ranges, it may be possible to prevent voids from being generated in the insulator of the heater assembly even after the heater assembly is manufactured. Accordingly, the reliability of the heater assembly may be ensured.

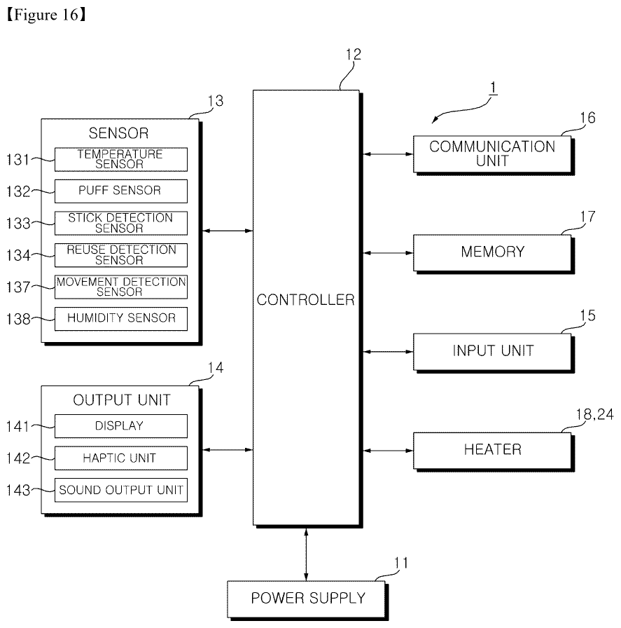

FIG. 16 is a block diagram of an aerosol-generating device 1 according to an embodiment of the present disclosure.

The aerosol-generating device 1 may include a power supply 11, a controller 12, a sensor 13, an output unit 14, an input unit 15, a communication unit 16, a memory 17, and one or more heaters 18 and 24. However, the internal structure of the aerosol-generating device 1 is not limited to that shown in FIG. 16. That is, it is to be understood by those skilled in the art that some of the components shown in FIG. 16 may be omitted or new components may be added depending on the design of the aerosol-generating device 1.

The sensor 13 may detect the state of the aerosol-generating device 1 or the state of the surrounding of the aerosol-generating device 1 and may transmit information about the detected state to the controller 12. Based on the information about the detected state, the controller 12 may control the aerosol-generating device 1 to perform various functions, such as control of operation of the cartridge heater 24 and/or the heater 18, smoking restriction, determination as to whether the stick S and/or the cartridge 19 is inserted, and notification display.

The sensor 13 may include at least one of a temperature sensor 131, a puff sensor 132, an insertion detection sensor 133, a reuse detection sensor 134, a movement detection sensor 137, or a humidity sensor 138.

The temperature sensor 131 may detect temperature to which the cartridge heater 24 and/or the heater 18 is heated. The aerosol-generating device 1 may include a separate temperature sensor configured to detect the temperature of the cartridge heater 24 and/or the heater 18, or the cartridge heater 24 and/or the heater 18 itself may serve as a temperature sensor.

The temperature sensor 131 may output a signal corresponding to the temperature of the cartridge heater 24 and/or the heater 18. For example, the temperature sensor 131 may include a resistive element that changes in resistance value according to a change in temperature of the cartridge heater 24 and/or the heater 18. The temperature sensor may be implemented as a thermistor, which is an element characterized in that the resistance thereof changes with temperature. In this case, the temperature sensor 131 may output a signal corresponding to the resistance value of the resistive element as a signal corresponding to the temperature of the cartridge heater 24 and/or the heater 18. For example, the temperature sensor 131 may be configured as a sensor configured to detect the resistance value of the cartridge heater 24 and/or the heater 18. In this case, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be disposed around the power supply 11 to monitor the temperature of the power supply 11. The temperature sensor 131 may be disposed adjacent to the power supply 11. For example, the temperature sensor 131 may be attached to one surface of the battery, which is the power supply 11. For example, the temperature sensor 131 may be mounted on one surface of a printed circuit board.

The temperature sensor 131 may be disposed in the body 10 to detect the internal temperature of the body 10.

The puff sensor 132 may detect a user puff based on various physical changes in a gasflow path. The puff sensor 132 may output a signal corresponding to a puff. For example, the puff sensor 132 may be a pressure sensor. The puff sensor 132 may output a signal corresponding to the internal pressure of the aerosol-generating device. Here, the internal pressure of the aerosol-generating device 1 may correspond to the pressure of the gasflow path through which gas flows. The puff sensor 132 may be disposed at a position corresponding to the gasflow path through which gas flows in the aerosol-generating device 1.

The stick detection sensor 133 may detect insertion and/or removal of the stick S. The stick detection sensor may be referred to as an insertion detection sensor. The insertion detection sensor 133 may detect a signal change caused by insertion and/or removal of the stick S. The insertion detection sensor 133 may be mounted around the insertion space. The insertion detection sensor 133 may detect insertion and/or removal of the stick S according to a change in dielectric constant in the insertion space. For example, the insertion detection sensor 133 may be an inductive sensor and/or a capacitance sensor.

The inductive sensor may include at least one coil. The coil of the inductive sensor may be disposed adjacent to the insertion space. For example, if a magnetic field changes around a coil through which current flows, the characteristics of the current flowing through the coil may change according to Faraday's law of electromagnetic induction. Here, the characteristics of the current flowing through the coil may include a frequency of alternating current, a current value, a voltage value, an inductance value, an impedance value, and the like.

The inductive sensor may output a signal corresponding to the characteristics of the current flowing through the coil. For example, the inductive sensor may output a signal corresponding to the inductance value of the coil.

The capacitance sensor may include a conductive body. The conductive body of the capacitance sensor may be disposed adjacent to the insertion space. The capacitance sensor may output a signal corresponding to the electromagnetic characteristics of the surroundings, for example, the capacitance around the conductive body. For example, if the stick S including a metallic wrapper is inserted into the insertion space, the electromagnetic characteristics around the conductive body may change due to the wrapper of the stick S.

The reuse detection sensor 134 may detect whether the stick S is being reused. The reuse detection sensor 134 may be a color sensor. The color sensor may detect the color of the stick S. The color sensor may detect the color of a portion of the wrapper surrounding the outer side of the stick S. The color sensor may detect, based on light reflected from an object, a value for the optical characteristic corresponding to the color of the object. For example, the optical characteristic may be the wavelength of light. The color sensor may be implemented as a component integrated with a proximity sensor or may be implemented as a component provided separately from a proximity sensor.

At least a portion of the wrapper constituting the stick S may change in color due to an aerosol. The reuse detection sensor 134 may be disposed at a position corresponding to a position at which at least a portion of the wrapper, which changes in color due to an aerosol, is disposed when the stick S is inserted into the insertion space. For example, before the stick S is used by the user, the color of at least a portion of the wrapper may be a first color. In this case, while the aerosol generated by the aerosol-generating device 1 passes through the stick S, at least a portion of the wrapper may become wet due to the aerosol, and accordingly, the color of at least a portion of the wrapper may change to a second color. After changing from the first color to the second color, the color of at least a portion of the wrapper may be maintained in the second color.

The movement detection sensor 137 may detect movement of the aerosol-generating device. The movement detection sensor 137 may be implemented as at least one of an acceleration sensor or a gyro sensor.

The humidity sensor 138 may detect the humidity of the aerosol-generating device and/or the cartridge. The humidity sensor 138 may detect the humidity of outside air and/or the humidity in the cartridge. The humidity sensor 138 may be implemented as a capacitive sensor or the like. The humidity sensor 138 may be disposed on the outer side of the body 10 or may be located in a path through which outside air is introduced to measure the humidity of the surroundings of the aerosol-generating device 1. The humidity sensor 138 may be located in the storage portion C0 of the cartridge 19 to measure the humidity in the cartridge 19.

In addition to the sensors 131 to 138 described above, the sensor 13 may further include at least one of a barometric pressure sensor, a magnetic sensor, a position sensor (GPS), or a proximity sensor. The functions of the sensors could be intuitively deduced by those skilled in the art from the names thereof, and thus detailed descriptions thereof will be omitted.

The output unit 14 may output information about the state of the aerosol-generating device 1 and may provide the information to the user. The output unit 14 may include at least one of a display 141, a haptic unit 142, or a sound output unit 143. However, the disclosure is not limited thereto. If the display 141 and a touchpad form a touchscreen together in a layered structure, the display 141 may be used as not only an output device but also an input device.

The display 141 may visually provide information about the aerosol-generating device 1 to the user. For example, the information about the aerosol-generating device 1 may include various pieces of information, such as a charging/discharging state of the power supply 11 of the aerosol-generating device 1, a preheating state of the heater 18, an insertion/removal state of the stick S and/or the cartridge 19, a mounting/removal state of the upper case, and a use restriction state of the aerosol-generating device 1 (e.g., detection of an abnormal article), and the display 141 may output the information to the outside. For example, the display 141 may be in the form of a light-emitting diode (LED) device. For example, the display 141 may be a liquid crystal display panel (LCD), an organic light-emitting display panel (OLED), or the like.

The haptic unit 142 may convert an electrical signal into mechanical stimulation or electrical stimulation to haptically provide the information about the aerosol-generating device 1 to the user. For example, if initial power is supplied to the cartridge heater 24 and/or the heater 18 for a predetermined amount of time, the haptic unit 142 may generate vibration corresponding to completion of initial preheating. The haptic unit 142 may include a vibration motor, a piezoelectric element, or an electrical stimulation device.

The sound output unit 143 may audibly provide information about the aerosol-generating device 1 to the user. For example, the sound output unit 143 may convert an electrical signal into an acoustic signal and may output the acoustic signal to the outside.

The power supply 11 may supply power used for operation of the aerosol-generating device 1. The power supply 11 may supply power so that the cartridge heater 24 and/or the heater 18 is heated. In addition, the power supply 11 may supply power necessary for operation of the other components provided in the aerosol-generating device 1, such as the sensor 13, the output unit 14, the input unit 15, the communication unit 16, and the memory 17. The power supply 11 may be a rechargeable battery or a disposable battery. For example, the power supply 11 may be a lithium polymer (LiPoly) battery. However, the disclosure is not limited thereto.

Although not shown in FIG. 16, the aerosol-generating device 1 may further include a power supply protection circuit. The power supply protection circuit may be electrically connected to the power supply 11 and may include a switching element.

The power supply protection circuit may block an electric path to the power supply 11 according to a predetermined condition. For example, the power supply protection circuit may block the electric path to the power supply 11 when the voltage level of the power supply 11 is equal to or higher than a first voltage corresponding to overcharge. For example, the power supply protection circuit may block the electric path to the power supply 11 when the voltage level of the power supply 11 is lower than a second voltage corresponding to overdischarge.

The heater 18 may receive power from the power supply 11 to heat the medium or the aerosol-generating substance in the stick S. Although not shown in FIG. 16, the aerosol-generating device 1 may further include a power conversion circuit (e.g., DC-to-DC converter) configured to convert the power of the power supply 11 and supply the converted power to the cartridge heater 24 and/or the heater 18. In addition, if the aerosol-generating device 1 generates an aerosol in an induction heating way, the aerosol-generating device 1 may further include a DC-to-AC converter configured to convert direct current power of the power supply 11 into alternating current power.

The controller 12, the sensor 13, the output unit 14, the input unit 15, the communication unit 16, and the memory 17 may perform functions using power received from the power supply 11. Although not shown in FIG. 16, the aerosol-generating device may further include a power conversion circuit configured to convert the power of the power supply 11 and supply the converted power to the respective components, for example, a low dropout (LDO) circuit or a voltage regulator circuit. In addition, although not shown in FIG. 16, a noise filter may be provided between the power supply 11 and the heater 18. The noise filter may be a low-pass filter. The low-pass filter may include at least one inductor and a capacitor. The cutoff frequency of the low-pass filter may correspond to the frequency of a high-frequency switching current applied from the power supply 11 to the heater 18. The low-pass filter may prevent high-frequency noise components from being applied to the sensor 13, for example, the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome. However, the disclosure is not limited thereto. In addition, the heater 18 may be implemented as a metal wire, a metal plate on which an electrically conductive track is disposed, or a ceramic heating element. However, the disclosure is not limited thereto.

In another embodiment, the heater 18 may be an induction heater. For example, the heater 18 may include a susceptor configured to generate heat through a magnetic field applied by a coil, thereby heating the aerosol-generating substance.

The input unit 15 may receive information input from the user or may output information to the user. For example, the input unit 15 may be a touch panel. The touch panel may include at least one touch sensor configured to detect touch. For example, the touch sensor may include a capacitive touch sensor, a resistive touch sensor, a surface acoustic wave touch sensor, an infrared touch sensor, etc. However, the disclosure is not limited thereto.

The display 141 and the touch panel may be implemented as an integrated panel. For example, the touch panel may be inserted into the display 141 (on-cell type touch panel or in-cell type touch panel). For example, the touch panel may be added onto the display 141 (add-on type touch panel).

Meanwhile, the input unit 15 may include a button, a keypad, a dome switch, a jog wheel, a jog switch, etc. However, the disclosure is not limited thereto.

The memory 17 may be hardware storing various pieces of data processed in the aerosol-generating device 1. The memory 17 may store data processed and to be processed by the controller 12. The memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. The memory 17 may store data on an operation time of the aerosol-generating device 1, the maximum number of puffs, the current number of puffs, at least one temperature profile, and the user's smoking pattern.

The communication unit 16 may include at least one component for communication with other electronic devices. For example, the communication unit 16 may include at least one of a short-range communication unit or a wireless communication unit.

The short-range communication unit may include a Bluetooth communication unit, a Bluetooth low energy (BLE) communication unit, a near-field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, etc. However, the disclosure is not limited thereto.

The wireless communication unit may include a cellular network communication unit, an Internet communication unit, a computer network (e.g., LAN or WAN) communication unit, etc. However, the disclosure is not limited thereto.

Although not shown in FIG. 16, the aerosol-generating device 1 may further include a connection interface such as a universal serial bus (USB) interface, and may be connected to other external devices through the connection interface such as a USB interface to transmit and receive information or charge the power supply 11.

The controller 12 may control overall operation of the aerosol-generating device 1. In an embodiment, the controller 1 may include at least one processor. The processor may be implemented as an array of a plurality of logic gates or may be implemented as a combination of a general-purpose microprocessor and a memory in which a program executable in the microprocessor is stored. Also, it will be understood by those skilled in the art that the processor can be implemented in other forms of hardware.

The controller 12 may control the supply of power from the power supply 11 to the heater 18 to control the temperature of the heater 18. The controller 12 may control the temperature of the cartridge heater 24 and/or the heater 18 based on the temperature of the cartridge heater 24 and/or the heater 18 detected by the temperature sensor 131. The controller 12 may control the power supplied to the cartridge heater 24 and/or the heater 18 based on the temperature of the cartridge heater 24 and/or the heater 18. For example, the controller 12 may determine a target temperature of the cartridge heater 24 and/or the heater 18 based on the temperature profile stored in the memory 17.

The aerosol-generating device 1 may include a power supply circuit (not shown) electrically connected to the power supply 11 between the power supply 11 and the cartridge heater 24 and/or the heater 18. The power supply circuit may be electrically connected to the cartridge heater 24, the heater 18, or the induction coil 181. The power supply circuit may include at least one switching element. The switching element may be implemented as a bipolar junction transistor (BJT), a field effect transistor (FET), or the like. The controller 12 may control the power supply circuit.

The controller 12 may control switching of the switching element of the power supply circuit to control the supply of power. The power supply circuit may be an inverter configured to convert direct current power output from the power supply 11 into alternating current power. For example, the inverter may be composed of a full-bridge circuit or a half-bridge circuit including a plurality of switching elements.

The controller 12 may turn on the switching element so that power is supplied from the power supply 11 to the cartridge heater 24 and/or the heater 18. The controller 12 may turn off the switching element so that the supply of power to the cartridge heater 24 and/or the heater 18 is interrupted. The controller 12 may control the frequency and/or the duty ratio of the current pulse input to the switching element to control the current supplied from the power supply 11.

The controller 12 may control switching of the switching element of the power supply circuit to control the voltage output from the power supply 11. The power conversion circuit may convert the voltage output from the power supply 11. For example, the power conversion circuit may include a buck-converter configured to step down the voltage output from the power supply 11. For example, the power conversion circuit may be implemented as a buck-boost converter, a Zener diode, or the like.

The controller 12 may control on/off operation of the switching element included in the power conversion circuit to control the level of the voltage output from the power conversion circuit. If the switching element is maintained in an on state, the level of the voltage output from the power conversion circuit may correspond to the level of the voltage output from the power supply 11. The duty ratio for the on/off operation of the switching element may correspond to a ratio of the voltage output from the power conversion circuit to the voltage output from the power supply 11. As the duty ratio for the on/off operation of the switching element decreases, the level of the voltage output from the power conversion circuit may decrease. The heater 18 may be heated based on the voltage output from the power conversion circuit.

The controller 12 may control the supply of power to the heater 18 using at least one of a pulse width modulation (PWM) scheme or a proportional-integral-differential (PID) scheme.

For example, the controller 12 may perform control using the PWM scheme such that a current pulse having a predetermined frequency and a predetermined duty ratio is supplied to the heater 18. The controller 12 may control the frequency and the duty ratio of the current pulse to control the power supplied to the heater 18.

For example, the controller 12 may determine, based on the temperature profile, a target temperature to be controlled. The controller 12 may control the power supplied to the heater 18 using the PID scheme, which is a feedback control scheme using a difference value between the temperature of the heater 18 and the target temperature, a value obtained by integrating the difference value with respect to time, and a value obtained by differentiating the difference value with respect to time.

The controller 12 may prevent the cartridge heater 24 and/or the heater 18 from overheating. For example, the controller 12 may control operation of the power conversion circuit such that the supply of power to the cartridge heater 24 and/or the heater 18 is interrupted when the temperature of the cartridge heater 24 and/or the heater 18 exceeds a predetermined limit temperature. For example, the controller 12 may reduce the amount of power supplied to the cartridge heater 24 and/or the heater 18 by a predetermined ratio when the temperature of the cartridge heater 24 and/or the heater 18 exceeds a predetermined limit temperature. For example, when the temperature of the cartridge heater 24 exceeds a limit temperature, the controller 12 may determine that the aerosol-generating substance contained in the cartridge 19 has been exhausted and may interrupt the supply of power to the cartridge heater 24.

The controller 12 may control charging/discharging of the power supply 11. The controller 12 may check the temperature of the power supply 11 based on an output signal from the temperature sensor 131.

If a power line is connected to a battery terminal of the aerosol-generating device 1, the controller 12 may determine whether the temperature of the power supply 11 is equal to or higher than a first limit temperature, which is a reference temperature at which charging of the power supply 11 is interrupted. When the temperature of the power supply 11 is lower than the first limit temperature, the controller 12 may perform control such that the power supply 11 is charged based on a predetermined charging current. When the temperature of the power supply 11 is equal to or higher than the first limit temperature, the controller 12 may interrupt charging of the power supply 11.

When the aerosol-generating device 1 is in an on state, the controller 12 may determine whether the temperature of the power supply 11 is equal to or higher than a second limit temperature, which is a reference temperature at which discharging of the power supply 11 is interrupted. When the temperature of the power supply 11 is lower than the second limit temperature, the controller 12 may perform control such that the power stored in the power supply 11 is used. When the temperature of the power supply 11 is equal to or higher than the second limit temperature, the controller 12 may interrupt use of the power stored in the power supply 11.

The controller 12 may calculate or determine the remaining amount of power stored in the power supply 11. For example, the controller 12 may calculate or determine the remaining capacity of the power supply 11 based on a voltage and/or current detection value of the power supply 11.

The controller 12 may determine whether the stick S is inserted into the insertion space using the insertion detection sensor 133. The controller 12 may determine that the stick S has been inserted based on an output signal from the insertion detection sensor 133. Upon determining that the stick S has been inserted into the insertion space, the controller 12 may perform control such that power is supplied to the cartridge heater 24 and/or the heater 18. For example, the controller 12 may supply power to the cartridge heater 24 and/or the heater 18 based on the temperature profile stored in the memory 17.

The controller 12 may determine whether the stick S is removed from the insertion space. For example, the controller 12 may determine whether the stick S is removed from the insertion space using the insertion detection sensor 133. For example, the controller 12 may determine that the stick S has been removed from the insertion space when the temperature of the heater 18 is equal to or higher than a limit temperature or when the temperature change slope of the heater 18 is equal to or greater than a predetermined slope. Upon determining that the stick S has been removed from the insertion space, the controller 12 may interrupt the supply of power to the cartridge heater 24 and/or the heater 18.

The controller 12 may control a power supply time and/or the amount of power supplied to the heater 18 depending on the state of the stick S detected by the sensor 13. The controller 12 may check, based on a look-up table, a level range within which the level of a signal from the capacitance sensor is included. The controller 12 may determine the amount of moisture in the stick S based on the checked level range.

When the stick S is in a highly humid state, the controller 12 may control a time during which power is supplied to the heater 18 to increase a preheating time of the stick S compared to when the stick S is in a normal state.

The controller 12 may determine whether the stick S inserted into the insertion space is a reused stick using the reuse detection sensor 134. For example, the controller 12 may compare a sensing value of a signal from the reuse detection sensor with a first reference range within which the first color is included, and may determine that the stick S is not a reused stick when the sensing value is within the first reference range. For example, the controller 12 may compare a sensing value of a signal from the reuse detection sensor with a second reference range within which the second color is included, and may determine that the stick S is a reused stick when the sensing value is within the second reference range. Upon determining that the stick S is a reused stick, the controller 12 may interrupt the supply of power to the cartridge heater 24 and/or the heater 18.

The controller 12 may determine whether the aerosol-generating substance in the cartridge 19 is exhausted. For example, the controller 12 may apply power to preheat the cartridge heater 24 and/or the heater 18, and may determine whether the temperature of the cartridge heater 24 exceeds a limit temperature in a preheating section. When the temperature of the cartridge heater 24 exceeds the limit temperature, the controller 12 may determine that the aerosol-generating substance in the cartridge 19 has been exhausted. Upon determining that the aerosol-generating substance in the cartridge 19 has been exhausted, the controller 12 may interrupt the supply of power to the cartridge heater 24 and/or the heater 18.

The controller 12 may make a determination as to a user puff using the puff sensor 132. For example, the controller 12 may determine, based on a sensing value of a signal from the puff sensor, whether a puff occurs. For example, the controller 12 may determine the intensity of a puff based on a sensing value of a signal from the puff sensor 132. When the number of puffs reaches a predetermined maximum number of puffs or when no puff is detected for a predetermined time period or longer, the controller 12 may interrupt the supply of power to the cartridge heater 24 and/or the heater 18.

The controller 12 may control the output unit 14 based on a result of detection by the sensor 13. For example, when the number of puffs counted through the puff sensor 132 reaches a predetermined number, the controller 12 may notify the user that operation of the aerosol-generating device 1 will end soon through at least one of the display 141, the haptic unit 142, or the sound output unit 143. For example, upon determining that the stick S is not present in the insertion space, the controller 12 may notify the user of the determination result through the output unit 14. For example, upon determining that the cartridge 19 and/or the upper case has not been mounted, the controller 12 may notify the user of the determination result through the output unit 14. For example, the controller 12 may transmit information about the temperature of the cartridge heater 24 and/or the heater 18 to the user through the output unit 14.

Upon determining that a predetermined event has occurred, the controller 12 may store a history of the corresponding event in the memory 17 and may update the history. The event may include events performed in the aerosol-generating device 1, such as detection of insertion of the stick S, commencement of heating of the stick S, detection of puff, termination of puff, detection of overheating of the cartridge heater 24 and/or the heater 18, detection of application of overvoltage to the cartridge heater 24 and/or the heater 18, termination of heating of the stick S, on/off operation of the aerosol-generating device 1, commencement of charging of the power supply 11, detection of overcharging of the power supply 11, and termination of charging of the power supply 11. The history of the event may include the occurrence date and time of the event and log data corresponding to the event. For example, when the predetermined event is detection of insertion of the stick S, the log data corresponding to the event may include data on a value detected by the insertion detection sensor 133. For example, when the predetermined event is detection of overheating of the cartridge heater 24 and/or the heater 18, the log data corresponding to the event may include data on the temperature of the cartridge heater 24 and/or the heater 18, the voltage applied to the cartridge heater 24 and/or the heater 18, and the current flowing through the cartridge heater 24 and/or the heater 18.

The controller 12 may perform control for formation of a communication link with an external device such as a user's mobile terminal. Upon receiving data on authentication from an external device via the communication link, the controller 12 may release restriction on use of at least one function of the aerosol-generating device 1. Here, the data on authentication may include data indicating completion of user authentication for the user corresponding to the external device. The user may perform user authentication through the external device. The external device may determine, based on the user's birthday or an identification number indicating the user, whether the user data is valid, and may receive data on the authority for use of the aerosol-generating device 1 from an external server. The external device may transmit data indicating completion of user authentication to the aerosol-generating device 1 based on the data on the use authority. When the user authentication is completed, the controller 12 may release restriction on use of at least one function of the aerosol-generating device 1. For example, when the user authentication is completed, the controller 12 may release restriction on use of a heating function for supplying power to the heater 18.

The controller 12 may transmit data on the state of the aerosol-generating device 1 to the external device through the communication link established with the external device. Based on the received state data, the external device may output the remaining capacity of the power supply 11 or the operation mode of the aerosol-generating device 1 through a display of the external device.

The external device may transmit a location search request to the aerosol-generating device 1 based on an input for commencement of search for the location of the aerosol-generating device 1. Upon receiving the location search request from the external device, the controller 12 may perform control, based on the received location search request, such that at least one of the output devices performs operation corresponding to location search. For example, the haptic unit 142 may generate vibration in response to the location search request. For example, the display 141 may output objects corresponding to location search and termination of search in response to the location search request.

Upon receiving firmware data from the external device, the controller 12 may perform control such that the firmware is updated. The external device may check the current version of the firmware of the aerosol-generating device 1 and may determine whether there is a new version of firmware. Upon receiving an input requesting firmware download, the external device may receive new version of firmware data and may transmit the new version of firmware data to the aerosol-generating device 1. Upon receiving the new version of firmware data, the controller 12 may perform control such that the firmware of the aerosol-generating device 1 is updated.

The controller 12 may transmit data on a value detected by the at least one sensor 13 to an external server (not shown) through the communication unit 16, and may receive, from the server, and store a learning model generated by learning the detected value through machine learning such as deep learning. The controller 12 may perform operation of determining the user's puff pattern and operation of generating the temperature profile using the learning model received from the server. The controller 12 may store data on the value detected by the at least one sensor 13 and data for training an artificial neural network (ANN) in the memory 17. For example, the memory 17 may store a database for each of the components provided in the aerosol-generating device 1 and weights and biases constituting the structure of the artificial neural network (ANN) in order to train the artificial neural network (ANN). The controller 12 may learn data on the value detected by the at least one sensor 13, the user's puff pattern, and the temperature profile, which are stored in the memory 17, and may generate at least one learning model used to determine the user's puff pattern and to generate the temperature profile.

As described above, according to at least one of the embodiments of the present disclosure, because the heater assembly is structured such that the through-hole is formed through the insulator formed outside the heating element, voids generated in the insulator may be discharged outside the insulator, and lifting or delamination of layers forming the insulator may be prevented.

According to at least one of the embodiments of the present disclosure, because the heater assembly is structured such that the outer surface of the heating element communicates with the outside of the insulator through the through-hole, voids generated in a contact portion between the heating element and the insulator may be discharged outside the insulator.

According to at least one of the embodiments of the present disclosure, because the heater assembly is structured such that the centers of holes forming the through-hole are disposed so as to be misaligned from each other, the areas of the layers of the insulator that are exposed to the inside of the through-hole may be increased, and thus voids generated in the layers of the insulator may be effectively discharged outside.

According to at least one of the embodiments of the present disclosure, because the sheet forming the insulator is rolled together with the heating element to manufacture the heater assembly and the manufactured heater assembly is aged, voids generated in the insulator during the manufacturing process may be discharged outside the insulator.

According to at least one of the embodiments of the present disclosure, because the heater assembly is aged based on a heating time and a heating temperature set within predetermined ranges, it may be possible to prevent the insulator from swelling or prevent a portion of the insulator from being lifted or delaminated from the heating element with the use of the aerosol-generating device.

According to at least one of the embodiments of the present disclosure, because the heating element disposed on the sheet-shaped insulator is rolled together with the insulator and then the heating element is thermally fused to the insulator, the process of manufacturing the heater assembly may be simplified, and the bonding structure of the heater assembly may be simplified.

According to at least one of the embodiments of the present disclosure, because the heating element disposed on the sheet-shaped insulator is rolled together with the insulator to form the heater assembly, the size of the device may be reduced.

Referring to FIGS. 1 to 16, an aerosol-generating device 1 in accordance with one aspect of the present disclosure may include a body 10 and a hollow heater assembly 30 disposed in the body 10 and providing an insertion space 43 with one side open. The heater assembly 30 may include a heating element 60 configured to heat the insertion space 43, an insulator 40 forming multiple layers surrounding the outer side of the heating element 60 in the radial direction of the insertion space 43, and a through-hole 70 formed through the multiple layers. The through-hole 70 may be formed by overlapping holes H1, H2, H3, and H4 formed in the multiple layers.

In addition, in accordance with another aspect of the present disclosure, at least some of the holes H1, H2, H3, and H4 forming the through-hole 70 may be disposed such that the centers thereof are misaligned from the centers of holes adjacent thereto in the radial direction of the insertion space 43.

In addition, in accordance with another aspect of the present disclosure, the multiple layers may include a first layer 40d1 disposed outside the heating element 60 in the radial direction of the insertion space 43 and having a first hole H1 formed therein and a second layer 40d2 disposed outside the first layer 40d1 while being in contact with the first layer 40d1 and having a second hole H2 formed therein, and the second hole H2 may be disposed such that the center C2 thereof is misaligned from the center C1 of the first hole H1.

In addition, in accordance with another aspect of the present disclosure, the first hole H1 may include a plurality of holes H1 aligned with each other in at least one row in the peripheral direction of the insertion space 43, and the second hole H2 may include a plurality of holes H2 aligned with each other in at least one row in the peripheral direction of the insertion space 43.

In addition, in accordance with another aspect of the present disclosure, the at least one row formed by the plurality of first holes H1 may be disposed such that a center thereof is misaligned from a center of the at least one row formed by the plurality of second holes H2 in the peripheral direction of the insertion space 43.

In addition, in accordance with another aspect of the present disclosure, the center C2 of the second hole H2 may be spaced apart from the center C1 of the first hole H1 by a distance less than the sum of the radius Rh2 of the second hole H2 and the radius Rh1 of the first hole H1.

In addition, in accordance with another aspect of the present disclosure, the center C2 of the second hole H2 may be spaced apart from the center C1 of the first hole H1 by a distance greater than the average of the radius Rh2 of the second hole H2 and the radius Rh1 of the first hole H1.

In addition, in accordance with another aspect of the present disclosure, the through-hole 70 may extend in the radial direction of the insertion space 43 and may allow the outer surface of the heating element 60 to communicate with the outside of the insulator 40.

In addition, in accordance with another aspect of the present disclosure, the through-hole 70 may include a plurality of through-holes 70 spaced apart from each other in the longitudinal direction of the insertion space 43.

In addition, in accordance with another aspect of the present disclosure, the aerosol-generating device may include a hollow susceptor 50 disposed inside the heating element 60 in the radial direction of the insertion space 43 and defining at least a portion of the insertion space 43, and the through-hole 70 may be disposed so as to overlap the susceptor 50 and the heating element 60 in the radial direction of the insertion space 43.

A method of manufacturing an aerosol-generating device in accordance with one aspect of the present disclosure may include a step of preparing an insulator 40 formed to be elongated (S1010), a step of placing a heating element 60 on the insulator 40 (S1020), a step of rolling the insulator 40 with the heating element 60 placed thereon to manufacture a heater assembly 30 including multiple layers surrounding the outer side of the heating element 60 (S1030), and a step of aging the heater assembly 30 (S1040).

In addition, in accordance with another aspect of the present disclosure, in step S1030 of manufacturing the heater assembly 30, holes H1, H2, H3, and H4 may be formed in the multiple layers so as to overlap each other, and a through-hole 70 may be formed through the multiple layers.

In addition, in accordance with another aspect of the present disclosure, step S1040 of aging the heater assembly 30 may include a step of keeping a chamber containing the heater assembly 30 at a first temperature for a first time period (S1045).

In addition, in accordance with another aspect of the present disclosure, the first temperature may be 280° C. to 300° C., and the first time period may be 3 hours to 5 hours.

In addition, in accordance with another aspect of the present disclosure, step S1040 aging the heater assembly 30 may further include a step of heating the chamber to the first temperature for a second time period shorter than the first time period (S1041), a step of keeping the chamber at the first temperature for a third time period longer than the second time period (S1042), a step of inserting a stick S into the heater assembly 30 and keeping the chamber at a second temperature lower than the first temperature for a fourth time period longer than the third time period (S1043), and a step of removing the stick S from the heater assembly 30 and heating the chamber to a third temperature for a fifth time period shorter than the fourth time period (S1044). Step S1045 of keeping the chamber at the first temperature for the first time period may be performed after step S1044 of heating the chamber to the third temperature for the fifth time period.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

The above detailed description should not be construed as restrictive in all respects but should be considered as illustrative. The scope of the present disclosure should be determined by reasonable interpretation of the appended claims, and all changes within the equivalent scope of the present disclosure are embraced within the scope of the present disclosure.

What is claimed is:

1. An aerosol-generating device comprising:
a body; and
a hollow heater assembly disposed in the body, the heater assembly providing an insertion space with one side open,
wherein the heater assembly comprises:
a heating element configured to heat the insertion space;
an insulator forming multiple layers surrounding an outer side of the heating element in a radial direction of the insertion space; and
a through-hole formed through the multiple layers, and
wherein the through-hole is formed by overlapping holes formed in the multiple layers.

2. The aerosol-generating device according to claim 1, wherein at least some of the holes forming the through-hole are disposed such that centers thereof are misaligned from centers of holes adjacent thereto in the radial direction of the insertion space.

3. The aerosol-generating device according to claim 2, wherein the multiple layers comprise:
a first layer disposed outside the heating element in the radial direction of the insertion space, the first layer having a first hole formed therein; and
a second layer disposed outside the first layer and in contact with the first layer, the second layer having a second hole formed therein, and
wherein the second hole is disposed such that a center thereof is misaligned from a center of the first hole.

4. The aerosol-generating device according to claim 3, wherein the first hole comprises a plurality of holes aligned with each other in at least one row in a peripheral direction of the insertion space, and
wherein the second hole comprises a plurality of holes aligned with each other in at least one row in the peripheral direction of the insertion space.

5. The aerosol-generating device according to claim 4, wherein the at least one row formed by the plurality of holes included in the first hole is disposed such that a center of thereof is misaligned from a center of the at least one row formed by the plurality of holes included in the second hole in the peripheral direction of the insertion space.

6. The aerosol-generating device according to claim 3, wherein the center of the second hole is spaced apart from the center of the first hole by a distance less than a sum of a radius of the second hole and a radius of the first hole.

7. The aerosol-generating device according to claim 3, wherein the center of the second hole is spaced apart from the center of the first hole by a distance greater than an average of a radius of the second hole and a radius of the first hole.

8. The aerosol-generating device according to claim 1, wherein the through-hole extends in the radial direction of the insertion space and allows an outer surface of the heating element to communicate with an outside of the insulator.

9. The aerosol-generating device according to claim 1, wherein the through-hole comprises a plurality of through-holes spaced apart from each other in a longitudinal direction of the insertion space.

10. The aerosol-generating device according to claim 1, comprising a hollow susceptor disposed inside the heating element in the radial direction of the insertion space, the susceptor defining at least a portion of the insertion space,
wherein the through-hole is disposed so as to overlap the susceptor and the heating element in the radial direction of the insertion space.

11. A method of manufacturing the aerosol-generating device described in claim 1, the method comprising:
preparing the insulator formed to be elongated;
placing the heating element on the insulator;
rolling the insulator with the heating element placed thereon to manufacture the heater assembly comprising multiple layers surrounding an outer side of the heating element; and
aging the heater assembly.

12. The method according to claim 11, wherein, in manufacturing the heater assembly, holes are formed in the multiple layers so as to overlap each other, and a through-hole is formed through the multiple layers.

13. The method according to claim 11, wherein aging the heater assembly comprises keeping a chamber containing the heater assembly at a first temperature for a first time period.

14. The method according to claim 13, wherein the first temperature is 280° C. to 300° C., and
wherein the first time period is 3 hours to 5 hours.

15. The method according to claim 13, wherein aging the heater assembly further comprises:
heating the chamber to the first temperature for a second time period shorter than the first time period;
keeping the chamber at the first temperature for a third time period longer than the second time period;
inserting a stick into the heater assembly and keeping the chamber at a second temperature lower than the first temperature for a fourth time period longer than the third time period; and
removing the stick from the heater assembly and heating the chamber to a third temperature for a fifth time period shorter than the fourth time period, and
wherein keeping the chamber at the first temperature for the first time period is performed after heating the chamber to the third temperature for the fifth time period.
